(19) United States
(12) Patent Application Publication
(10) Pub. No.: US 2010/0053348 A1
(43) Pub. Date: Mar. 4, 2010

(54) IMAGE CAPTURE DEVICE, IMAGE ANALYSIS DEVICE, EXTERNAL LIGHT INTENSITY CALCULATION METHOD, IMAGE ANALYSIS METHOD, IMAGE CAPTURE PROGRAM, IMAGE ANALYSIS PROGRAM, AND STORAGE MEDIUM

(76) Inventors: Yoshiharu YOSHIMOTO, Osaka-shi (JP); Akira Fujiwara, Osaka-shi (JP); Daisuke Yamashita, Osaka-shi (JP)

Correspondence Address: BIRCH STEWART KOLASCH & BIRCH, PO BOX 747, FALLS CHURCH, VA, 22040-0747, US

(21) Appl. No.: 12/548,930

(22) Filed: Aug. 27, 2009

(30) Foreign Application Priority Data
Aug. 29, 2008 (JP) 2008-222870

(51) Int. Cl. H04N 5/225; G06F 3/041

(52) U.S. Cl. 348/218.1; 345/173; 348/E05.024

(57) ABSTRACT

A touch position detection device (10) is provided in proximity of image capture sensors (12) and includes at least one external light sensor (15) having a lower light detection sensitivity than the image capture sensors (12) and an external light intensity calculation section (3) for calculating an external light intensity which is the intensity of light in the surroundings of a pointing member according to the quantity of light received by the external light sensor (15). Therefore, the external light intensity in the surroundings of the pointing member with which to point at an image capture screen containing the image capture sensors can be accurately calculated.

This nonprovisional application claims priority under 35 U.S.C. §119(a) on Patent Application No. 2008-222870 filed in Japan on Aug. 29, 2008, the entire contents of which are hereby incorporated by reference.

### TECHNICAL FIELD

The present invention relates to image capture devices for capturing an image of a pointing member for pointing on an image capture screen containing a plurality of image capture sensors, image analysis devices and methods for analyzing the captured image, and external light intensity calculation methods for calculating the intensity of light in the surroundings of the pointing member.

### BACKGROUND ART

Displays which can double as image capture devices have been developed in recent years by building light sensors in the pixels of display devices, such as LCDs (liquid crystal displays) and OLEDs (organic light emitting diodes). Development is also under way for touch panel technology utilizing images captured, by the display device with built-in light sensors, of a pointing device (e.g., a user's finger or a stylus) pointing at a position on the surface of the display device. For example, Patent Literature 1 (Japanese Patent Application Publication, Tokukai, No. 2006-244446 (Publication Date: Sep. 14, 2006) describes touch panel technology based on an LCD with built-in light sensors. Throughout the following description, the user's finger and the pointing device will be collectively referred to as the pointing member.

As can be seen in the example above, a technique to provide a touch panel based on the LCD with built-in light sensors has been developed. Problems arise, however, where the images acquired by the light sensors show great variations depending on the intensity and incident direction of external light, or light in the surroundings of the finger (or pointing device) touching the touch panel. Image analysis where due consideration is given to the effects of the external light is necessary to distinguish between touch and non-touch in those highly variable images with good precision.

In this context, Patent Literature 2 (Japanese Patent Application Publication, Tokukai, No. 2007-183706 (Publication Date: Jul. 19, 2007) attempts to deal with changes in external light by detecting the intensity of the external light through user inputs or with an external light sensor and switching between image processing methods depending on whether or not the intensity is in excess of a threshold.

Meanwhile, Patent Literature 3 (Japanese Patent Application Publication, Tokukai, No. 2004-318819 (Publication Date: Nov. 11, 2004) determines the ratio of black and white portions in an image to determine the intensity of external light and switch between image processing methods.

Both Patent Literatures 2 and 3 fail to determine external light intensity with good precision.

Concretely, in Patent Literature 2, the external light sensor, provided for the detection of the external light, is installed too far away from an image-acquisition light sensor to accurately calculate the intensity of external light incident to the image-acquisition light sensor.

Patent Literature 3 only roughly determines the intensity of external light from the ratio of black and white portions in an image captured. This is way short of being capable of accurate calculation of the external light intensity.

Furthermore, neither Patent Literature 2 nor 3 discloses the calculated external light intensity being used in the processing of images of a pointing member pointing at a position on a touch panel to improve precision in the touch/non-touch distinguishment.

### SUMMARY OF THE INVENTION

The present invention, conceived to address these problems, has an objective of providing an image capture device and an external light intensity calculation method which enable accurate calculation of external light intensity. The present invention has another objective of using the external light intensity in the processing of images of a pointing member in order to improve precision in the touch/non-touch distinguishment.

An image capture device in accordance with the present invention is, to achieve the objectives, characterized in that it is an image capture device including an image capture screen containing a plurality of image capture sensors, the device capturing an image of a pointing member being placed near the image capture screen with the plurality of image capture sensors, the device including:

at least one external light sensor provided in proximity to the plurality of image capture sensors, the external light sensor having a lower light detection sensitivity than the plurality of image capture sensors; and

external light intensity calculation means for calculating an external light intensity which is an intensity of light from the surroundings of the pointing member, the external light intensity calculation means calculating the external light intensity according to a quantity of the light received by the external light sensor.

An external light intensity calculation method in accordance with the present invention is characterized in that it is an external light intensity calculation method implemented by an image capture device including an image capture screen containing a plurality of image capture sensors, the device capturing an image of a pointing member being placed near the image capture screen with the plurality of image capture sensors, the method including:

the external light intensity calculation step of calculating an external light intensity which is an intensity of light incident to at least one external light sensor from the surroundings of the pointing member, the external light intensity calculation step of calculating the external light intensity according to a quantity of the light received by the external light sensor, the external light sensor being provided in proximity to the plurality of image capture sensors and having a lower light detection sensitivity than the plurality of image capture sensors.

According to these configurations, at least one external light sensor having a lower light detection sensitivity than a plurality of image capture sensors is provided in proximity to the plurality of image capture sensors. The external light intensity calculation means calculates an external light intensity, or the intensity of light in the surroundings of the pointing member, according to the quantity of light received by the external light sensor. The calculated external light intensity is used, for example, to adjust the sensitivity of the plurality of image capture sensors or to process a captured image.

If the high-sensitivity image capture sensors are used to calculate the external light intensity, the output values (pixel values) of the image capture sensors will likely saturate frequently. In the configurations above, the external light sensor has a lower detection sensitivity than the image capture sensors. The output value of the external light sensor thus will less likely saturate. The external light intensity will more likely be calculated accurately.

An image analysis device in accordance with the present invention is characterized in that it is an image analysis device for analyzing an image of a pointing member being placed near an image capture screen containing a plurality of image capture sensors, the image being captured by the plurality of image capture sensors, the device including:

reception means for receiving the captured image;

reference level calculation means for calculating, from an external light intensity which is an intensity of light in the surroundings of the pointing member, a pixel value reference level according to which to remove an image other than an image of a part, of the pointing member, which is in contact with the image capture screen from the captured image; and

image processing means for altering a pixel value for at least one of pixels contained in the captured image according to the reference level calculated by the reference level calculation means.

An image analysis method in accordance with the present invention is characterized in that it is an image analysis method implemented by an image analysis device for analyzing an image of a pointing member being placed near an image capture screen containing a plurality of image capture sensors, the image being captured by the plurality of image capture sensors, the method including:

the reception step of receiving the captured image;

the reference level calculation step of calculating, from an external light intensity which is an intensity of light in the surroundings of the pointing member, a pixel value reference level according to which to remove an image other than an image of a part, of the pointing member, which is in contact with the image capture screen from the captured image; and

the image processing step of altering a pixel value for at least one of pixels contained in the captured image according to the reference level calculated in the reference level calculation step.

According to these configurations, the reference level calculation means calculates a pixel value reference level according to which to remove an image other than an image of a part, of an image capture object, which is in contact with the image capture screen (information unnecessary in recognizing the image capture object) from the captured image according to an estimated value of the external light intensity. The image processing means alters a pixel value for at least one of pixels contained in the captured image according to the reference level calculated by the reference level calculation means to remove information unnecessary in recognizing the image capture object from the captured image.

Hence, the information unnecessary in recognizing the image capture object is removed from the captured image. The image capture object is recognized with high precision.

Another image analysis device in accordance with the present invention is characterized in that it is an image analysis device for analyzing an image of a pointing member being placed near an image capture screen containing a plurality of image capture sensors, the image being captured by the plurality of image capture sensors, the device including:

reception means for receiving the captured image;

feature region extraction means for extracting a feature region showing a feature of an image of the pointing member from the captured image received by the reception means;

reference level calculation means for calculating, from an external light intensity which is an intensity of light in the surroundings of the pointing member, a pixel value reference level according to which to determine whether or not the feature region is attributable to an image of a part, of the pointing member, which is in contact with the image capture screen;

removing means for removing a feature region attributable to a pixel having a pixel value greater than or equal to the reference level calculated by the reference level calculation means from the feature region extracted by the feature region extraction means; and

position calculation means for calculating a position of the image of the part, of the pointing member, which is in contact with the image capture screen from a feature region not removed by the removing means.

Another image analysis method in accordance with the present invention is characterized in that it is an image analysis method implemented by an image analysis device for analyzing an image of a pointing member being placed near an image capture screen containing a plurality of image capture sensors, the image being captured by the plurality of image capture sensors, the method including:

the reception step of receiving the captured image;

the feature region extraction step of extracting a feature region showing a feature of an image of the pointing member contained in the captured image received in the reception step;

the reference level calculation step of calculating, from an external light intensity which is an intensity of light in the surroundings of the pointing member, a pixel value reference level according to which to determine whether or not the feature region is attributable to a part, of the pointing member, which is in contact with the image capture screen;

the removing step of removing a feature region attributable to a pixel having a pixel value greater than or equal to the reference level calculated in the reference level calculation step from the feature region extracted in the feature region extraction step; and

the position calculation step of calculating a position of an image of the part, of the pointing member, which is in contact with the image capture screen from a feature region not removed in the removing step.

According to these configurations, the feature region extraction means extracts a feature region showing a feature of an image of the pointing member from the captured image. The reference level calculation means calculates, from the external light intensity, a pixel value reference level according to which to determine whether or not the feature region is attributable to an image of a part, of the pointing member, which is in contact with the image capture screen. The removing means removes the feature region attributable to pixels having pixel values greater than or equal to the reference level from the feature region extracted by the feature region extraction means. The position calculation means calculates the position of the image of the part, of the pointing member, which is in contact with the image capture screen from the feature region not removed by the removing means.

Hence, the feature region is removed which is attributable to the image of the pointing member not in contact with the image capture screen and which is unnecessary in recognizing the pointing member. The pointing member is recognized with high precision.

Additional objectives, advantages and novel features of the invention will be set forth in part in the description which follows, and in part will become apparent to those skilled in the art upon examination of the following or may be learned by practice of the invention.

### BRIEF DESCRIPTION OF DRAWINGS

FIG. 1 is a block diagram of a touch position detection device in accordance with an embodiment of the present invention.

FIG. 2(a) is an illustration of an exemplary arrangement of image capture sensors and external light sensors.

FIG. 2(b) is an illustration of another exemplary arrangement of image capture sensors and external light sensors.

FIG. 3 is an illustration of relationship between external light intensity and histograms generated by an external light intensity calculation section.

FIG. 4 is an illustration of exemplary ambient brightness in capturing an image of a pointing member and captured images.

FIG. 5 is a cross-sectional view of a variation of a touch panel section.

FIG. 6 is an illustration of exemplary ambient brightness in capturing an image of a pointing member and captured images with an elastic film being provided.

FIG. 7 is an illustration of exemplary touched and non-touched captured images.

FIG. 8(a) is a graph representing a relationship between ambient lighting intensity and pixel values in a captured image.

FIG. 8(b) is an illustration of exemplary images captured under different ambient lighting intensities.

FIG. 9 is a graph which describes a touch/non-touch threshold pixel value.

FIG. 10(a) is a graph representing another example of changes in pixel values below a finger pad upon a touch and non-touch versus changes in ambient lighting intensity.

FIG. 10(b) is a graph representing still another example of changes in pixel values below a finger pad upon a touch and non-touch versus changes in ambient lighting intensity.

FIG. 11 is an illustration of a process carried out by an unnecessary recognition information removal section.

FIG. 12 is an illustration of problems which occur when external light intensity reaches saturation.

FIG. 13 is an illustration of exemplary images captured when sensitivity is switched and when it is not switched.

FIG. 14(a) is an illustration of an exemplary calculation of a touch/non-touch threshold pixel value using image capture sensors.

FIG. 14(b) is an illustration of an exemplary calculation of a touch/non-touch threshold pixel value using external light sensors.

FIG. 15 is an illustration of advantages of calculation of external light intensity using external light sensors.

FIG. 16 is a flow chart depicting an exemplary touch position detection carried out by the touch position detection device.

FIG. 17 is a block diagram of a touch position detection device in accordance with another embodiment of the present invention.

FIG. 18 is an illustration of processing carried out by the unnecessary recognition information removal section.

FIG. 19 is a flow chart depicting an exemplary touch position detection carried out by the touch position detection device.

### DESCRIPTION OF EMBODIMENTS

### Embodiment 1

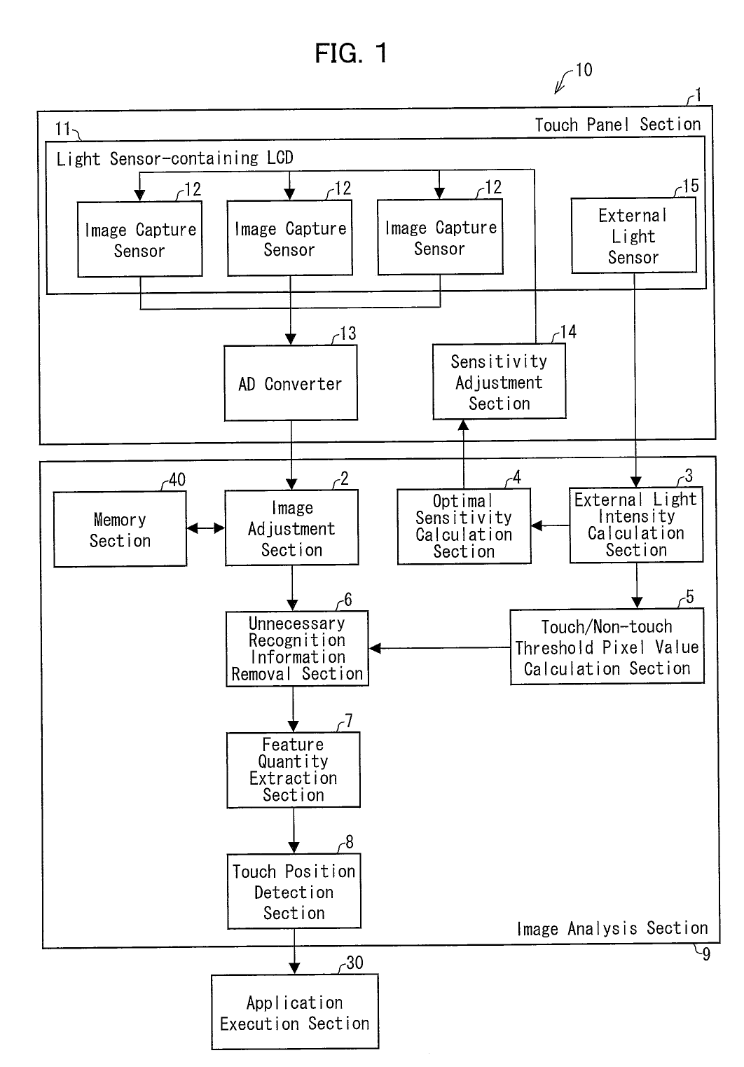

The following will describe an embodiment of the present invention in reference to FIGS. 1 to 16. The description will take, as an embodiment of the present invention, a touch position detection device 10 which captures images of a user's finger or thumb or a stylus or like pointing device (collectively, a “pointing member”) pointing at a position on a touch panel to detect the position pointed at by the pointing members from the images. The touch position detection device may alternatively called the display device, the image capture device, the input device, or the electronics.

### Configuration of Touch Position Detection Device 10

FIG. 1 is a block diagram of the touch position detection device 10 in accordance with the present embodiment. As illustrated in FIG. 1, the touch position detection device (image analysis device, image capture device) 10 includes a touch panel section (image capture section) 1, an image analysis section (image analysis device) 9, and an application execution section 30.

The image analysis section 9 includes an image adjustment section 2, an external light intensity calculation section (external light intensity calculation means) 3, an optimal sensitivity calculation section (sensitivity setup means) 4, a touch/non-touch threshold pixel value calculation section (reference level calculation means) 5, an unnecessary recognition information removal section (image processing means) 6, a feature quantity extraction section (feature region extraction means) 7, and a touch position detection section (position calculation means) 8.

The touch panel section 1 includes a light sensor-containing LCD 11, an AD (analog/digital) converter 13, and a sensitivity adjustment section 14. The LCD 11 includes built-in image capture sensors, or image capture elements for image acquisition, 12 and an external light sensor 15 for external light intensity detection.

With the built-in image capture sensors 12, the light sensor-containing LCD (liquid crystal panel or display device) 11 is capable of not only display, but also image capturing. Therefore, the light sensor-containing LCD 11 functions as an image capture screen for capturing an image (hereinafter, “captured image” or “sensor image”) containing the pointing member with which the surface of the light sensor-containing LCD 11 as the touch panel is touched. In other words, the image capture sensors 12 capture an image of the pointing member being placed near the light sensor-containing LCD, or image capture screen, 11.

Each pixel in the light sensor-containing LCD 11 has one image capture sensor 12. In other words, the image capture sensors 12 are arranged in a matrix inside the light sensor-containing LCD 11. However, the arrangement and number of the image capture sensors 12 are not limited to these specific examples and may be altered if necessary.

Signals produced by the image capture sensors 12 are digitized by the AD converter 13 for output to the image adjustment section 2.

The external light sensor 15 has lower light detection sensitivity than the image capture sensors 12. The external light sensor 15 preferably has such sensitivity that it produces substantially the same pixel value as or a lower pixel value than that of the image capture sensors 12 if an image of a finger pad is captured when a finger (pointing member) is placed on the light sensor-containing LCD 11 containing the image capture sensors 12 in certain lighting intensity environments.

The external light sensor 15 may be almost insensitive to visible light, but sensitive to some degree to infrared light. That is, the external light sensor 15 may primarily receive infrared light as the external light.

An explanation is given here as to why the external light sensor 15 is made sensitive to some degree only to infrared light. The finger (pointing member) blocks substantially all visible light while transmitting infrared light to some degree. What needs to be predicted is changes in the light transmitted through the finger pad which would occur depending on the intensity of the external light. Therefore, the external light sensor 15, if made sensitive primarily to infrared light, facilitates prediction of transmission of light through the finger.

In other words, the external light sensor 15 is less sensitive to the light that does not pass through the finger which is the pointing member (visible light) than to the light that passes through the finger (infrared light).

FIG. 1 shows only one external light sensor 15. Preferably, however, two or more external light sensors 15 are provided as will be detailed later.

The touch position detection device 10 uses the light sensor-containing LCD 11 to acquire captured images from which the touch position is detected and information from which the external light intensity is calculated (received light quantity for each external light sensor 15).

The image adjustment section 2 carries out processes including calibration by which to adjust the gain and offset of the captured image captured by the touch panel section 1 and outputs the adjusted captured image to the unnecessary recognition information removal section 6. The following description assumes that an 8-bit, 256-level grayscale image is output. The image adjustment section 2 functions also as reception means for receiving the captured image from the touch panel section 1. The image adjustment section 2 may store the received or adjusted captured image in a memory section 40.

The external light intensity calculation section 3 obtains an output value indicating the received light quantity output from the external light sensor 15 to calculate the external light intensity from the obtained output value. The external light intensity calculation section 3 outputs the calculated external light intensity to the optimal sensitivity calculation section 4 and the touch/non-touch threshold pixel value calculation section 5. The processing carried out by the external light intensity calculation section 3 will be detailed later. The external light intensity is defined as the intensity of light in the surroundings of the pointing member (image capture object).

The optimal sensitivity calculation section 4 calculates the optimal sensitivity of the image capture sensors 12, which recognize the pointing member according to the external light intensity calculated by the external light intensity calculation section 3 or the touch/non-touch threshold pixel value calculated by the touch/non-touch threshold pixel value calculation section 5, for output to the sensitivity adjustment section 14. The processing carried out by the optimal sensitivity calculation section 4 will be detailed later.

The sensitivity adjustment section 14 adjusts the sensitivity of the image capture sensors 12 to an optimal sensitivity output from the optimal sensitivity calculation section 4.

The touch/non-touch threshold pixel value calculation section 5 calculates a pixel value reference level (touch/non-touch threshold pixel value) according to which the unnecessary recognition information removal section 6 removes information that is unnecessary in recognizing the pointing member from the captured image. In other words, the touch/non-touch threshold pixel value calculation section 5 calculates from the external light intensity (intensity of light in the surroundings of the pointing member) a pixel value reference level according to which to remove, from the captured image, the portions of the image other than those of the part of the image capture object which is in contact with the light sensor-containing LCD 11.

More specifically, the touch/non-touch threshold pixel value calculation section 5 calculates, from the external light intensity calculated by the external light intensity calculation section 3, a touch/non-touch threshold pixel value which is a reference level for the pixels according to which to remove the image of the pointing member from the captured image when the pointing member is not in contact with the light sensor-containing LCD 11. Alternatively, the touch/non-touch threshold pixel value calculation section 5 may be described as calculating, from the external light intensity calculated by the external light intensity calculation section 3, a touch/non-touch threshold pixel value (determination reference level) which is a pixel value reference level according to which to determine whether or not the image contained in the captured image is attributable to the part, of the pointing member, which is in contact with the light sensor-containing LCD 11. The processing carried out by the touch/non-touch threshold pixel value calculation section 5 will be detailed later.

The unnecessary recognition information removal section 6 alters pixel values for some of the pixels contained in the captured image on the basis of the touch/non-touch threshold pixel value calculated by the touch/non-touch threshold pixel value calculation section 5. More specifically, the unnecessary recognition information removal section 6 obtains the touch/non-touch threshold pixel value calculated by the touch/non-touch threshold pixel value calculation section 5 and replaces pixel values for the pixels contained in the captured image which are greater than or equal to the touch/non-touch threshold pixel value with the touch/non-touch threshold pixel value, to remove information that is unnecessary in recognizing the pointing member from the captured image.

For each pixel in the captured image, the feature quantity extraction section 7 extracts a feature quantity indicating a feature of the pointing member (edge feature quantity) from the captured image processed by the unnecessary recognition information removal section 6 using a Sobel filter or by a similar edge detection technique. The feature quantity extraction section 7 extracts the feature of the pointing member quantity, for example, as a feature quantity including eight-direction vectors indicating inclination (gradation) directions of the pixel value in eight directions around the target pixel.

Specifically, the feature quantity extraction section 7 calculates a longitudinal direction inclination quantity indicating the inclination between the pixel value for the target pixel and the pixel value for an adjacent pixel in the longitudinal direction and a lateral direction inclination quantity indicating the inclination between the pixel value for the target pixel and the pixel value for an adjacent pixel in the lateral direction, and identifies an edge pixel where brightness changes abruptly from these longitudinal and lateral direction inclination quantities. The section 7 then extracts as the feature quantity a vector indicating the inclination of the pixel value at the edge pixel.

The feature quantity extraction section 7 may perform any feature quantity extraction provided that the shape of the pointing member (especially, its edges) can be detected. The feature quantity extraction section 7 may carry out conventional pattern matching or like image processing to detect an image of the pointing member (feature region). The feature quantity extraction section 7 outputs the extracted feature quantity and the pixel from which the feature quantity is extracted to the touch position detection section 8 in association with each other. Feature quantity information is associated with each pixel in the captured image and generated, for example, as a feature quantity table.

The touch position detection section 8 performs pattern matching on the feature region showing the feature quantity extracted by the feature quantity extraction section 7 to identify a touch position. Specifically, the touch position detection section 8 performs pattern matching between a predetermined model pattern of a plurality of pixels for which the inclination direction of the pixel value is indicated and a pattern of the inclination direction indicated by the feature quantity extracted by the feature quantity extraction section 7 and detects, as an image of the pointing member, a region where the number of pixels whose inclination direction matches the inclination direction in the model pattern reaches a predetermined value. Any pattern matching technique may be used here provided that it is capable of appropriately identifying the position of an image of the pointing member. The touch position detection section 8 outputs coordinates representing the identified touch position to the application execution section 30.

Based on the coordinates output from the touch position detection section 8, the application execution section 30 executes an application corresponding to the coordinates or carry out a process corresponding to the coordinates in a particular application. The application execution section 30 may execute any kind of application.

Arrangement of Image Capture Sensors 12 and External Light sensor 15

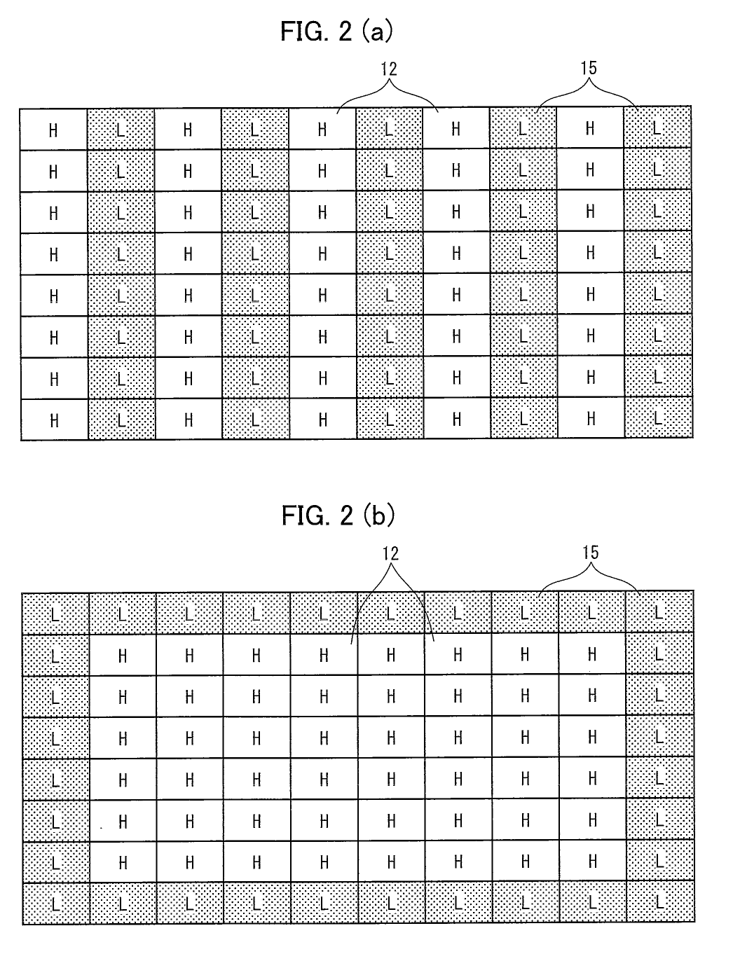

FIG. 2(a) and 2(b) are illustrations of an arrangement of image capture sensors 12 and external light sensors 15. A column of image capture sensors 12 (indicated by an H) and a column of external light sensors 15 (indicated by an L) may be arranged alternately in the light sensor-containing LCD 11 as illustrated in FIG. 2(a). In other words, the external light sensors 15 may be arranged between the image capture sensors 12. In this arrangement, the sensors 12 and 15 can equally receive external light falling on the light sensor-containing LCD 11. The number of image capture sensors 12 needs to be reduced by half; the captured image comes to show lower resolution.

Alternatively, as illustrated in FIG. 2(b), the image capture sensors 12 may be surrounded by the external light sensors 15. In other words, the external light sensors 15 may be arranged adjacent to outer edge sections of the region where the image capture sensors 12 are arranged. When this is the case, the image capture sensors 12 are replaced only along the periphery of the region where the image capture sensors 12 can be provided; the captured image can substantially retain the resolution. In addition, since the external light sensors 15 are arranged on all the four sides of the rectangular region where the image capture sensors 12 are provided. The pointing member is less likely to block the external light incident to the external light sensors 15.

On the other hand, since the external light sensors 15 are arranged only around the region where the image capture sensors 12 are provided, the quantity of information on external light intensity may decrease, and the sensors 12 and 15 may not be able to equally receive the external light falling onto the light sensor-containing LCD 11. Therefore, under some conditions, the external light intensity may not be calculated as precisely as with the arrangement shown in FIG. 2(a).

Any arrangement other than those presented above may be employed for the image capture sensors 12 and the external light sensors 15 provided that it enables calculation of external light intensity.

It is not essential to provide both the image capture sensors 12 and the external light sensors 15, which show mutually different sensitivity, in the same light sensor-containing LCD 11. Nevertheless, this arrangement is preferred because the image capture sensors 12 and the external light sensors 15 can receive external light under the same conditions. In other words, the external light sensors 15 are preferably provided close to the image capture sensors 12.

### Processing by External Light Intensity Calculation Section 3 in Detail

Next will be described in detail the processing carried out by the external light intensity calculation section 3.

The external light intensity calculation section 3 selects at least some of the output values (pixel values) of the external light sensors 15 which indicate received light quantity and takes as the external light intensity a selected output value that is ranked at a predetermined place in a descending order listing of all the selected output values.

A plurality of output values of the external light sensors 15 may be treated as pixel values for the image. In that case, the external light sensors 15 may be described as acquiring an external light intensity calculation image for use in external light intensity calculation. In that case, the external light intensity calculation section 3 selects at least some of the pixels contained in the external light intensity calculation image output from the image adjustment section 2 and takes as the external light intensity the pixel value for a selected pixel that is ranked at a predetermined place in a descending order listing of all the pixel values for the selected pixels.

That is, the external light intensity calculation section 3 generates a histogram representing a relationship between pixel values in descending order and the number of pixels having those pixel values, for the pixels contained in the external light intensity calculation image. The section 3 generates the histogram preferably from pixel values for all the pixels in the external light intensity calculation image. In view of cost, process speed, or another contributing factor, however, the section 3 does not need to use all the pixels that make up the external light intensity calculation image (i.e., the output values of all the external light sensors 15). Instead, some of the pixel values for the external light intensity calculation image may be selectively used: for example, those for the pixels that belong to equally distanced rows/columns.

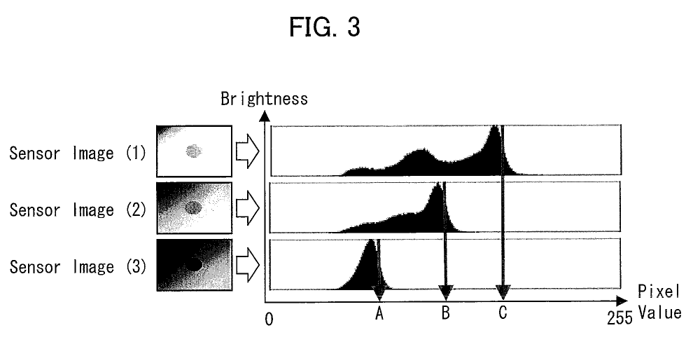

FIG. 3 is an illustration of relationship between histograms generated by the external light intensity calculation section 3 and external light intensities. External light intensity is measured when a finger is placed on the touch panel section 1 in environments with different external light intensities. As illustrated in FIG. 3, the section 3 generates different histograms. The pixel value distribution in the histograms shift toward the higher end as the external light intensity increases. Note in FIG. 3 that A indicates the external light intensity for the captured sensor image (3), B for the captured sensor image (2), and C for the captured sensor image (1).

Next, in the calculation of external light intensity from the generated histogram, the pixel values (output values) in the histogram are counted starting from the highest value. The pixel value (output value) when the count reaches a certain proportion of the number of the pixel values (output values) used in the generation of the histogram is employed as the external light intensity value.

An explanation is given here as to why the pixel value ranked at the top few percent in the histogram is taken as the external light intensity as above. For example, different external light intensity calculation images are acquired depending on how the finger or hand is positioned, leading to different histograms being generated from these external light intensity calculation images, even under the same external light intensity.

Those of the pixels contained in the external light intensity calculation image which more accurately reflect the external light intensity show higher pixel values than the other pixels because when the external light is blocked by a finger or hand, the pixel values for the pixels in the external light intensity calculation image are lowed.

Therefore, when external light intensity is calculated from a histogram, variations in the calculated value due to the positioning of the finger or hand can be reduced to minimum by calculating the external light intensity from the pixel value for the pixel which is ranked at the top few percent of the pixel values.

However, if the external light intensity is calculated from a pixel value which is ranked, for example, at the top 0.1% or at a similarly high place in the histogram, the precision will decrease due to defective pixel values in the external light intensity calculation image. Preferably, the external light intensity is calculated from the pixel value ranked at the top single-digit percent. In other words, the place of the pixel showing a pixel value employed as the external light intensity in a descending order listing of pixel values for the pixels selected from those in the external light intensity calculation image preferably matches a value less than 10% of the total count of the selected pixels. In other words, preferably, the external light intensity calculation section 3 takes as the external light intensity the output value ranked at a predetermined place in a descending order listing of the selected output values of the external light sensors 15, and the predetermined place in the listing matches a value less than 10% of the total count of the selected output values.

The external light intensity calculation section 3 may not necessarily use histograms to determine the external light intensity. An alternative example is to limit regions of the external light intensity calculation image in which sample points are taken, obtain an average pixel values for the pixels (sample points) in each of the limited regions, and employ the largest average pixel value as the external light intensity.

### Processing by Touch/Non-touch Threshold Pixel Value Calculation Section 5 in Detail

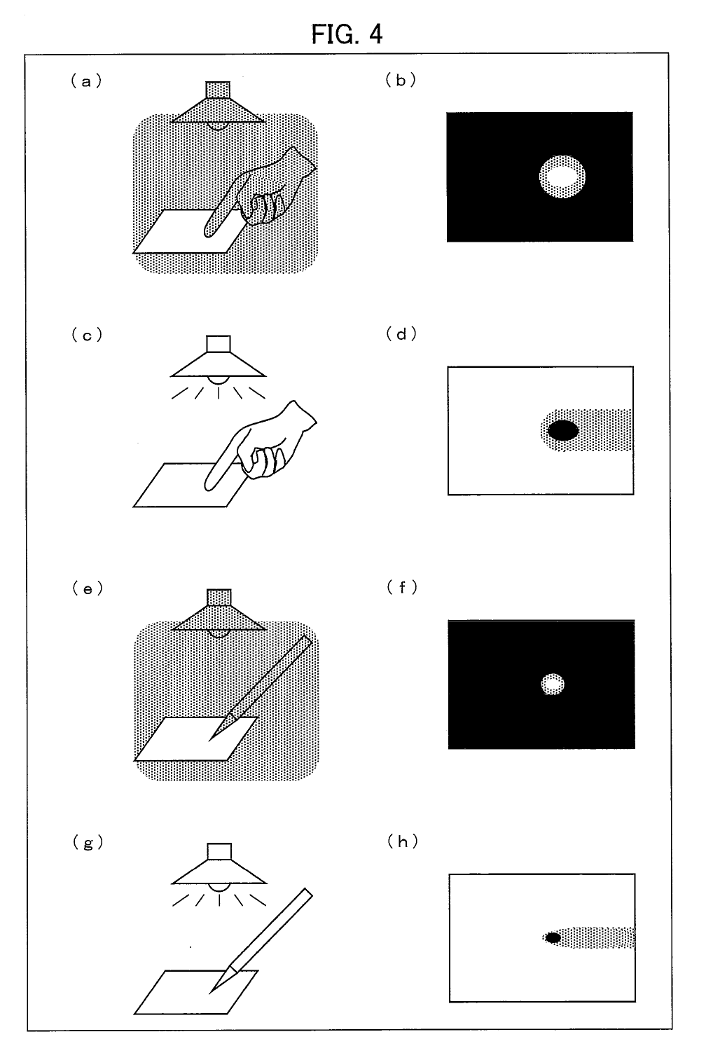

Before the touch/non-touch threshold pixel value calculation section 5 is described, it will be described in reference to FIG. 4 how a touch or non-touch is captured as an image by the image capture sensors 12. FIGS. 4(a), 4(c), 4(e), and 4(g) show ambient brightness in capturing an image of the pointing member. FIGS. 4(b), 4(d), 4(f), and 4(h) show exemplary captured images.

In a conventional light sensor panel, at the part of the finger which touches the panel, the finger pad reflects light from a backlight so that the light enters a sensor. As shown in FIG. 4(b), when the external light is weaker than the reflection from the finger pad, the finger pad appears as a bright, white circle than the background. As shown in FIG. 4(d), when the reflection from the finger pad is stronger than the external light, the finger pad appears as a dark, black circle than the background. The same description applies to a pen.

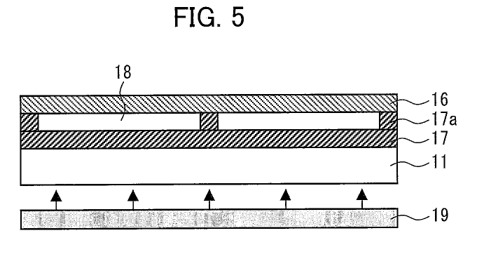

Another scheme is based on such a configurational variation of the touch position detection device 10 that the pixel values in the background can be always greater than the pixel values for the pixels which form the image of the finger pad, or the pointing member (hereinafter, the “pixel values below the finger pad”). FIG. 5 is a cross-sectional view of a variation of the touch panel section 1. As illustrated in FIG. 5, there may be provided a transparent substrate 16 and an elastic film 17 on the front side of the light sensor-containing LCD 11 and a backlight 19 on the other side of the LCD 11.

The elastic film 17 has projections 17a which form an air layer 18 between the transparent substrate 16 and the elastic film 17. The air layer 18 reflects light from the backlight 19 when there is no pressure being applied to the front side of the transparent substrate 16. In contrast, when there is pressure being applied thereto, the air layer 18 reflects no light, reducing the overall reflectance. With this mechanism, the pixel values for the pixels touched by the finger (pixel values below the finger pad) are always lower than the pixel values in the background.

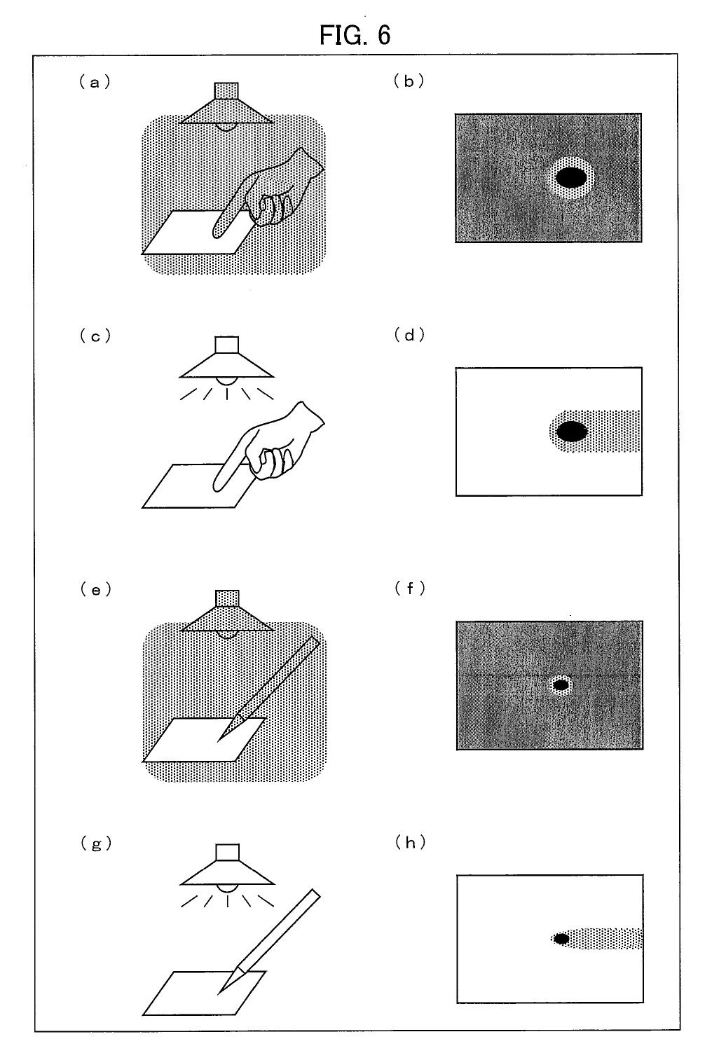

FIG. 6 shows exemplary images captured with the elastic film 17 being provided. The working mechanism of the elastic film 17 ensures that the part pressed by the finger is darker than the background even when the surroundings are completely dark; the part pressed by the finger is kept dark. The pressed part is similarly kept dark even when the external light is strong. The same description applies to a pen.

The following description will deal with the touch panel section 1 having the elastic film 17 when the pixel values are lower below the finger pad than in the background.

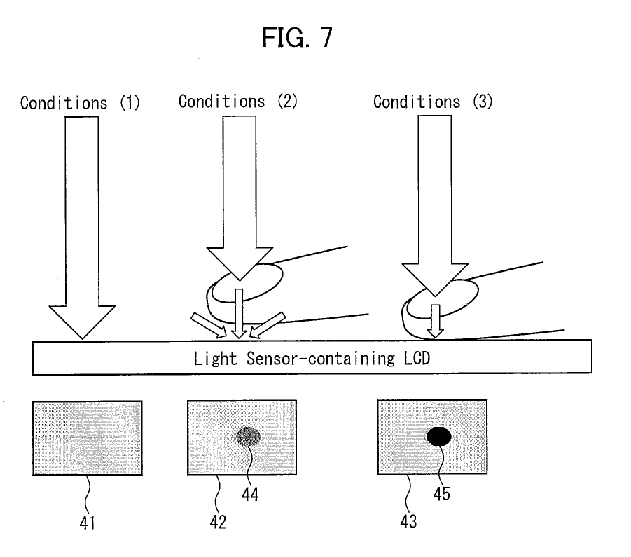

FIG. 7 shows how a touch or non-touch is captured as an image by the image capture sensors 12. If the external light directly enters the image capture sensors 12 without the finger or any other things being placed on the LCD 11, an image 41 containing no image of the finger (only the background image) is obtained as in conditions (1) in FIG. 7. If the finger is placed close to the top of the light sensor-containing LCD 11, but not actually touching it, as in conditions (2) in FIG. 7, an image 42 is obtained containing a thin shadow 44 of the finger. An image 43 containing a darker shadow 45 than the shadow 44 in the image 42 is obtained if the finger is being pressed completely against the light sensor-containing LCD 11 as in conditions (3) in FIG. 7.

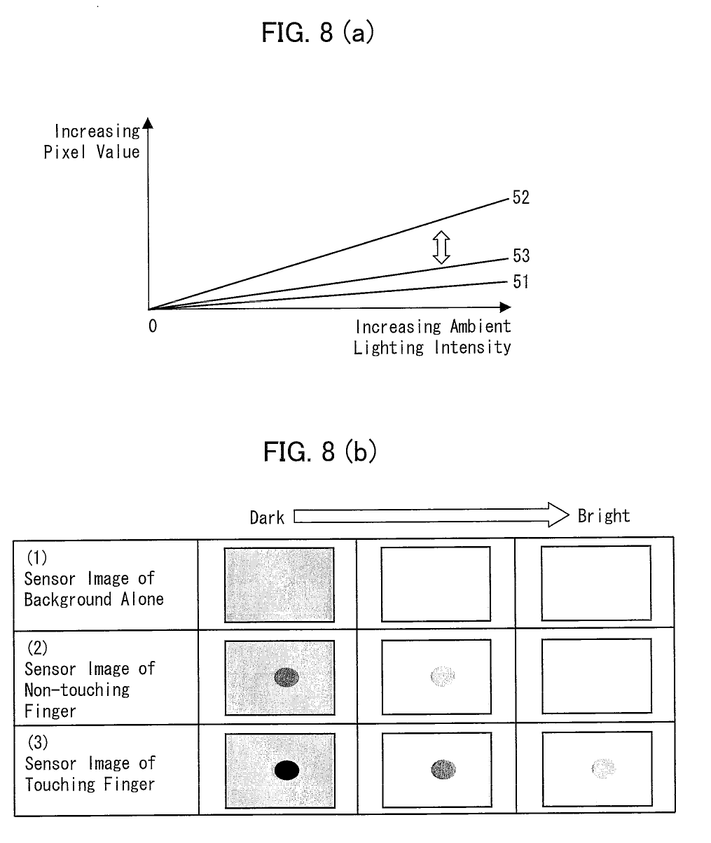

FIG. 8(a) shows a relationship between the external light intensity obtained by the external light intensity calculation section 3, the pixel values below the non-touched finger pad in the image 42 in FIG. 7, and the pixel values below the touched finger pad in the image 43 in FIG. 7. As illustrated in FIG. 8(a), the external light intensity (indicated by reference no. 51), the pixel values below the non-touched finger pad (indicated by reference no. 52), and the pixel values below the touched finger pad (indicated by reference no. 53) grow larger with increasing external light intensity. FIG. 8(b) show captured images under these varying conditions.

In FIG. 8(a), the pixel values below the non-touched finger pad are always greater than the pixel values below the touched finger pad. Therefore, there is always a gap (difference) between the pixel values below the non-touched finger pad and the pixel values below the touched finger pad.

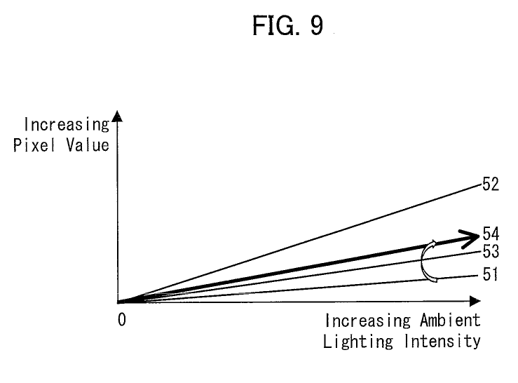

Provided that this relationship holds, if a threshold (indicated by reference no. 54) can be specified between the pixel values below the non-touched finger pad (indicated by reference no. 52) and the pixel values below the touched finger pad (indicated by reference no. 53) as illustrated in FIG. 9, those pixel values which are greater than or equal to the threshold can be removed as information unnecessary in the recognition, which improves precision in the recognition.

Accordingly, the touch/non-touch threshold pixel value calculation section 5 dynamically calculates a touch/non-touch threshold pixel value, which is a pixel value between the pixel values below the non-touched finger pad and the pixel values below the touched finger pad, based on changes in the external light intensity.

However, it is impossible to obtain the pixel values below the touched finger pad and the pixel values below the non-touched finger pad during online processing (while the user is actually touching the light sensor-containing LCD 11). Therefore, the touch/non-touch threshold pixel value is calculated by plugging the external light intensity into an equation which, prepared in advance, representing the relationship between the external light intensity obtainable on site and the touch/non-touch threshold pixel value.

The equation is given in the following as equation (1). The touch/non-touch threshold pixel value (T) can be calculated by plugging the external light intensity (A) calculated by the external light intensity calculation section 3 into this equation.

Math. 1

T=AX (1)

where X is a predetermined constant. To determine X, N in equation (2) below is set to a certain value so that the value satisfies the equation.

Math. 2

T=(B+C)/N (2)

where B is pixel values below the non-touched finger pad, C is pixel values below the touched finger pad, and N may take any given value provided that T falls between B and C.

From equation (2), X which satisfies equation (3) below is calculated.

Math. 3

T=AX=(B+C)/N (3)

During online processing, the touch/non-touch threshold pixel value calculation section 5 substitutes the value of A calculated by the external light intensity calculation section 3 into equation (1) for every frame to calculate T.

Equation (1) may be stored in a memory section (for example, in the memory section 40) for access by the touch/non-touch threshold pixel value calculation section 5.

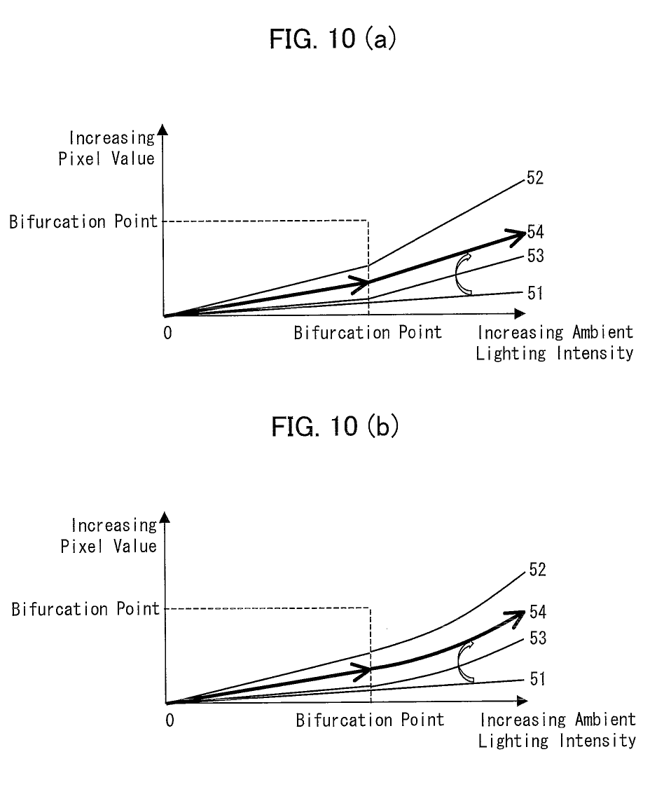

FIGS. 10(a) and 10(b) are graphs representing other examples of changes in the pixel values below a finger pad upon a touch and non-touch versus changes in ambient lighting intensity.

If the characteristics of the touch and non-touch pixel values change at the bifurcation points as shown in FIGS. 10(a) and 10(b), the touch/non-touch threshold pixel value may be calculated using different equations before and after the bifurcation point (point at which the external light intensity reaches a certain pixel value).

In other words, two different equations from which the touch/non-touch threshold pixel value is obtained may be stored in the memory section 40 so that the touch/non-touch threshold pixel value calculation section 5 can use the two different equations respectively before and after the external light intensity calculated by the external light intensity calculation section 3 reaches a predetermined value. In other words, the touch/non-touch threshold pixel value calculation section 5 may selectively use a plurality of equations from which the touch/non-touch threshold pixel value is obtained according to the external light intensity calculated by the external light intensity calculation section 3.

The two different equations are, for example, equation (1) with different values assigned to the constant X.

Alternatively, the touch/non-touch threshold pixel value may be set substantially equivalent to the pixel values below the touched finger pad. In that case, the constant X in equation (1) may be determined so that the touch/non-touch threshold pixel value is equivalent to the pixel values below the touched finger pad.

If the external light sensors 15 is set up in terms of sensitivity so as to output substantially the same pixel value as the pixel values below the touched finger pad in a certain lighting intensity environment, the output value of the external light intensity calculation section 3 may be used as is as the touch/non-touch threshold pixel value. In that case, there is no need to provide the touch/non-touch threshold pixel value calculation section 5.

### Processing by Unnecessary Recognition Information Removal Section 6 in Detail

The touch/non-touch threshold pixel value obtained as above is output to the unnecessary recognition information removal section 6. The unnecessary recognition information removal section 6 replaces the pixel values, for the pixels in the captured image, which are greater than or equal to the touch/non-touch threshold pixel value obtained by the touch/non-touch threshold pixel value calculation section 5 with the touch/non-touch threshold pixel value, to remove information that is unnecessary in recognizing the pointing member.

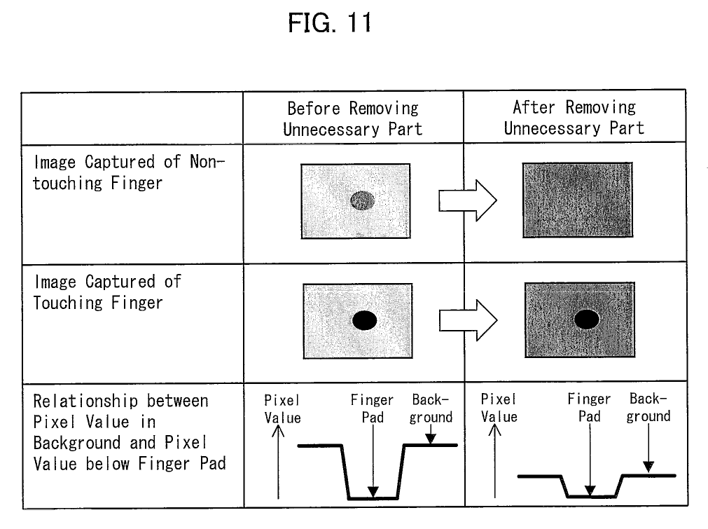

FIG. 11 is an illustration of a process carried out by the unnecessary recognition information removal section 6. The relationship between background pixel values and pixel values below a finger pad is shown at the bottom of the figure.

In other words, the pixels having greater pixel values than the touch/non-touch threshold pixel value can be safely regarded as not being related to the formation of an image of a pointing member touching the light sensor-containing LCD 11. Therefore, as illustrated in FIG. 11, replacing the pixel values, for the pixels, which are greater than or equal to the touch/non-touch threshold pixel value with the touch/non-touch threshold pixel value removes the unnecessary image from the background of the pointing member.

### Advantages of External Light Sensors 15

Next will be described problems in the touch/non-touch threshold pixel value calculation section 5 calculating the external light intensity from the output values of the image capture sensors 12, in other words, advantages in the touch/non-touch threshold pixel value calculation section 5 calculating the external light intensity from the output values of the external light sensors 15.

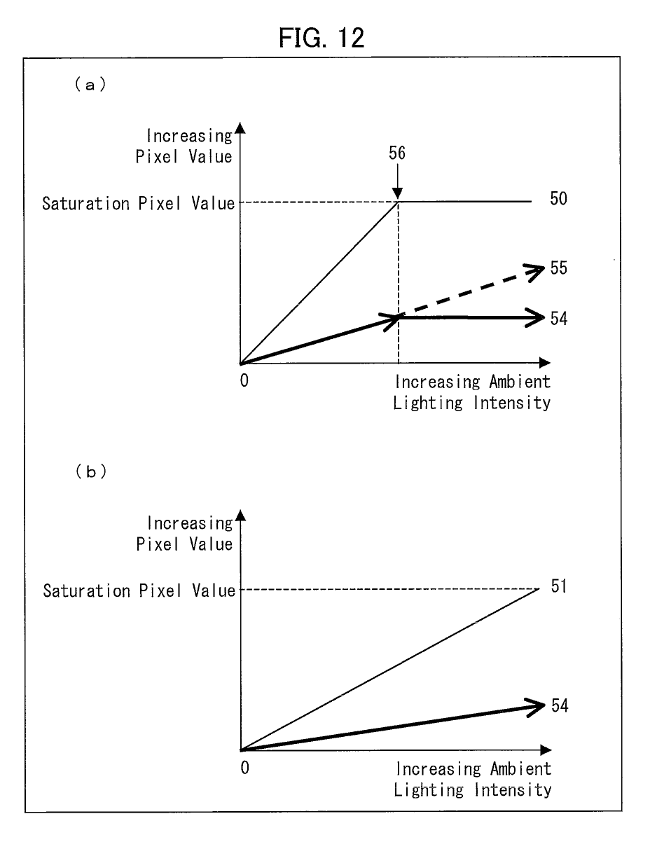

FIG. 12 is an illustration of problems in the calculation of the external light intensity using the image capture sensors 12.

In the calculation of the external light intensity using the image capture sensors 12, if the intensity of the external light incident to the image capture sensors 12 increases by such a large amount that the calculated external light intensity (indicated by reference no. 50) reaches a saturation pixel value as illustrated in FIG. 12(a), it becomes impossible to calculate the increase of the external light intensity beyond the saturation point.

Therefore, the touch/non-touch threshold pixel value, which is calculated from the external light intensity, cannot be accurately calculated. In the worst case, even when a finger is placed on the panel, all the pixels saturate, producing a pure white image. In FIG. 12(a), reference no. 54 indicates the touch/non-touch threshold pixel value calculated when the external light intensity has reached the saturation pixel value, and reference no. 55 indicates the (actual) touch/non-touch threshold pixel value when the external light intensity has not reached the saturation pixel value.

To solve this problem, the sensitivity of the image capture sensors 12 needs to be reduced as illustrated in FIG. 12(b) so that the external light intensity does not reach the saturation point. This sensitivity reducing process prevents the external light intensity from reaching the saturation point, thereby enabling accurate calculation of the touch/non-touch threshold pixel value. The sensitivity of the image capture sensors 12 is switched when the external light intensity reaches the saturation point (point indicated by reference no. 56 in FIG. 12(a)) or immediately before that.

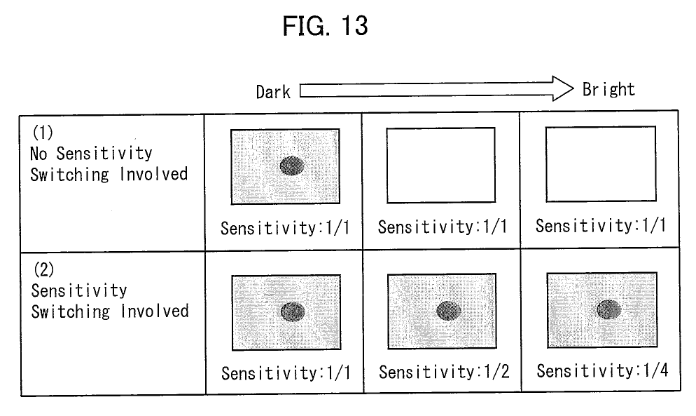

FIG. 13 shows exemplary captured images with and without sensitivity switching. The top row in FIG. 13 involves no sensitivity switching. When no sensitivity switching is involved, the pixel values below the finger pad, along with the background pixel values, increase with the increasing external light intensity due to the light transmitted by the finger; all the pixels reach saturation, ending up with a pure white image. Accurate touch position detection is impossible based on such an image.

In contrast, as shown in the bottom row in FIG. 13, when sensitivity switch is involved, the background pixel values and the pixel values below the finger pad do not reach the saturation point even at the same external light intensity as in the case where no sensitivity switching is involved because sensitivity is reduced. The image is maintained in the state where the touch position can be detected.

However, if the external light intensity is calculated using the image capture sensors 12 as in this example, the sensitivity is switched upon the external light intensity calculated by the external light intensity calculation section 3 reaching the saturation pixel value even when the pixel values below the finger pad (substantially equivalent to the touch/non-touch threshold pixel value) has not reached the saturation point.

If the sensitivity is not switched when the external light intensity has reached the saturation point, the sensitivity switching point may be lost, the touch/non-touch threshold pixel value may be not accurately calculated, or the recognition is otherwise inconvenienced.

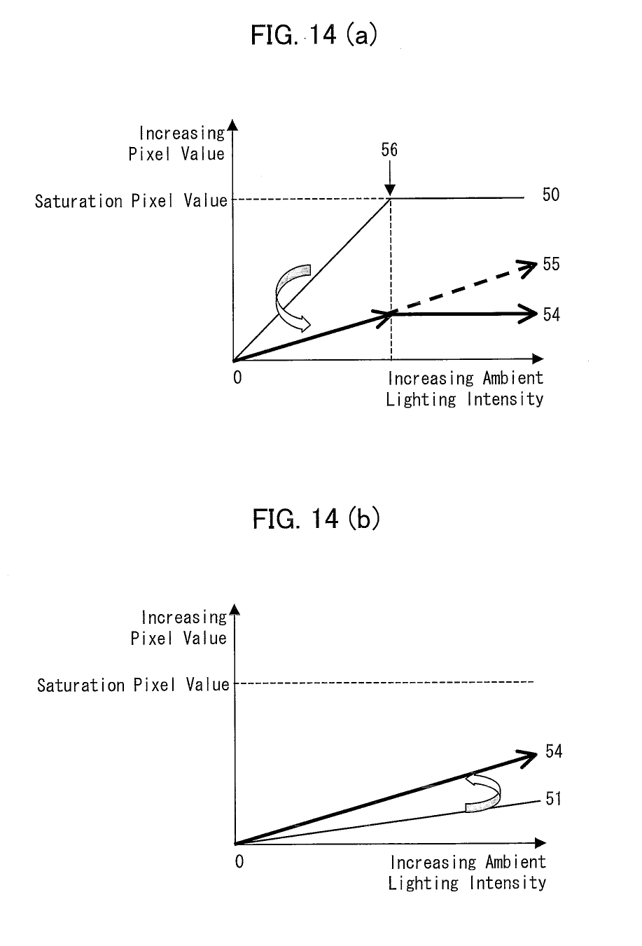

In contrast to this, as illustrated in FIG. 14(b), if the external light intensity is calculated from the output values of the external light sensors 15, the sensitivity does not need to be forcefully reduced when the pixel values below the finger pad (substantially equivalent to the touch/non-touch threshold pixel value) have not reached the saturation point even when the external light intensity calculated from the image capture sensors 12 has already reached the saturation point as illustrated in FIG. 14 (a), because the external light intensity calculated from the external light sensors 15 has not reached the saturation point. FIGS. 14(a) and 14(b) are illustrations of advantages in the calculation of the touch/non-touch threshold pixel value from the external light sensors 15.

As described in the foregoing, more regions for the external light intensity in which the image capture sensors 12 can be maintained at high sensitivity can be secured by calculating the external light intensity from the external light sensors 15 which have lower sensitivity than the image capture sensors 12.

In addition, the sensitivity switching for the image capture sensors 12 takes some time; if the switching is frequently done, time loss occurs. The frequency of the sensitivity switching for the image capture sensors 12 is lowered if the external light intensity is calculated from the external light sensors 15 than if the external light intensity is calculated from the image capture sensors 12; therefore, time loss due to the operation of the touch position detection device 10 is reduced.

### Preferred Sensitivity of External Light Sensors 15

The external light sensors 15 preferably has such a sensitivity that the pixel value for the external light sensors 15 in a certain lighting intensity environment is substantially the same pixel value as the pixel values for the image capture sensors 12 capturing an image of the finger pad of the finger (pointing member) placed on the light sensor-containing LCD 11 containing the image capture sensors 12. In other words, the sensitivity of the external light sensors 15 is set so that the external light sensors 15 can detects as the external light the light having the intensity corresponding to substantially the same pixel value as the pixel values for the image capture sensors 12 capturing an image of the finger pad of the finger (pointing member) placed on the light sensor-containing LCD 11 containing the image capture sensors 12.

Referring to FIG. 14(b), if the touch/non-touch threshold pixel value is substantially equivalent to the pixel values below the touched finger pad, and the touch/non-touch threshold pixel value (indicated by reference no. 54) and the external light intensity calculated by the external light intensity calculation section 3 (indicated by reference no. 51) are of the same value, when the pixel values below the touched finger pad reach the saturation point, the external light intensity calculated by the external light intensity calculation section 3 also simultaneously reaches the saturation point. Therefore, the external light intensity calculated by the external light intensity calculation section 3 may be used as is as the touch/non-touch threshold pixel value, which facilitates the calculation of the touch/non-touch threshold pixel value.

### How External Light Sensors 15 Deliver the Effects

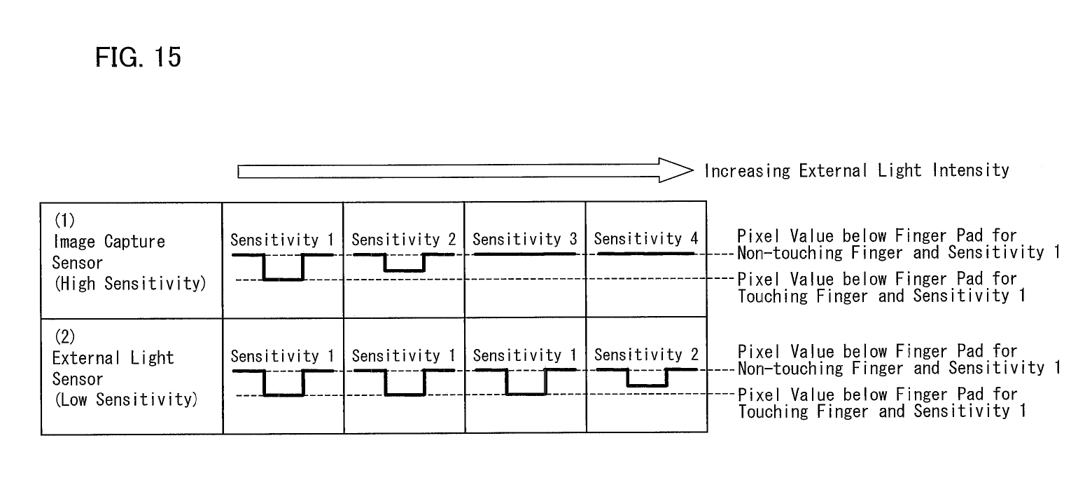

An explanation is given here in reference to FIG. 15 specifically as to how a high sensitivity can be maintained for the image capture sensors 12 if the external light intensity is calculated using the output values of the external light sensors 15. FIG. 15 is an illustration of advantages of the calculation of the external light intensity using the external light sensors 15.

(1) in FIG. 15 shows an exemplary case where the external light intensity is calculated using the image capture sensors 12 and the sensitivity of the image capture sensors 12 is switched. (2) in FIG. 15 shows an exemplary case where the external light intensity is calculated using the external light sensors 15 and the sensitivity of the image capture sensors 12 is switched. The external light intensity is the lowest at the left of the figure and grows larger toward the right.

FIG. 15 conceptually illustrates differences between the pixel values below the touched finger pad and the pixel values below the non-touched finger pad according to external light intensities for various sensitivities. For simple description, the figure only shows touch/non-touch differences caused by difference in sensitivity, while neglecting effects of the light transmitted by the finger pad and of the light entering below the finger pad. In addition, the sensitivity is highest at “1” and degrades as the numeral grows larger.

In the example given in (1) in FIG. 15, the sensitivity of the image capture sensors 12 is reduced every time the external light intensity is increased. Therefore, the difference in the pixel values below the finger pad between when the finger is touching and when the finger is not touching gradually decreases and at sensitivity 3, reaches zero.

In contrast, in the example in (2) in FIG. 15, the external light intensity is calculated using the external light sensors 15 which exhibit a poorer sensitivity than the image capture sensors 12; therefore, the timing at which the sensitivity of the image capture sensors 12 is decreased can be shifted toward a part where the external light intensity is higher than in the case in (1) in FIG. 15. In the example in (2) in FIG. 15, the difference in the pixel values below the finger pad between when the finger is touching and when the finger is not touching can be maintained even at a part where there is no more difference in the pixel values below the finger pad between when the finger is touching and when the finger is not touching in the example in (1) in FIG. 15 because the sensitivity of the image capture sensors 12 can be maintained at a high value.

Since reducing the sensitivity of the image capture sensors 12 makes it progressively difficult to distinguish between a touch and a non-touch with decreasing touch/non-touch difference in the pixel values below the finger pad, maintaining the sensitivity of the image capture sensors 12 at a high value directly leads to improvement in precision in the recognition of the finger (pointing member).

As described in the foregoing, the calculation of the external light intensity using the external light sensors 15 which exhibit a poorer sensitivity than the image capture sensors 12 enables the timing at which the sensitivity of the image capture sensors 12 is decreased to be delayed and enables the recognition using images for which a high sensitivity is maintained. Accordingly, precision in the recognition is improved.

### Processing by Optimal Sensitivity Calculation Section 4 in Detail

Next will described in detail an optimal sensitivity calculation carried out by the optimal sensitivity calculation section 4. First, the description will deal with calculation in which the sensitivity of the image capture sensors 12 is decreased.

Referring to FIG. 14(b), when the pixel value is set to be lower for the calculated external light intensity (indicated by reference no. 51) than the pixel values below the finger pad (substantially equivalent to the touch/non-touch threshold pixel value (indicated by reference no. 54)), the external light intensity does not reach the saturation point before the pixel values below the finger pad.

Therefore, if the sensitivity of the image capture sensors 12 is reduced when the calculated external light intensity has reached the saturation point, the captured image is pure white because the pixel values below the finger pad has already reached the saturation point; the touch position cannot be detected.

Accordingly, if the external light intensity is calculated using the output values of the external light sensors 15, the sensitivity of the image capture sensors 12 is reduced before (or when) the pixel values below the finger pad reach the saturation point. For example, the touch/non-touch threshold pixel value calculation section 5 may employ the calculated touch/non-touch threshold pixel value as a reference for the saturation point for the pixel values below a finger pad, and the sensitivity switching may be triggered by the touch/non-touch threshold pixel value reaching the saturation point.

Alternatively, the external light intensity at which or immediately before the pixel values below the finger pad are predicted to reach the saturation point (reference external light intensity) may be set in advance. If the optimal sensitivity calculation section 4 determines that the external light intensity calculated by the external light intensity calculation section 3 has reached the reference external light intensity, the optimal sensitivity calculation section 4 lowers the sensitivity of the image capture sensors 12.

In addition, the optimal sensitivity calculation section 4 preferably lowers the sensitivity of the image capture sensors 12 in stages, for example, from 1/1 to ½ and to ¼ because if the sensitivity of the image capture sensors 12 is lowered more than necessary, the luminance of the captured image decreases, and the precision in the recognition of the pointing member decreases.

Next will be described an exemplary case where the sensitivity of the image capture sensors 12 is increased. First, the description will deal with a case where the optimal sensitivity calculation section 4 sets the sensitivity of the image capture sensors 12 on the basis of the touch/non-touch threshold pixel value calculated by the touch/non-touch threshold pixel value calculation section 5. The following description assumes for convenience that the pixel value calculated by the external light intensity calculation section 3 when the external light intensity reaches the saturation point is 255.

If the sensitivity of the image capture sensors 12 is set to ¼ and the touch/non-touch threshold pixel value is less than or equal to 64, about a quarter of the saturation level, 255, a sensitivity UP process is implemented to restore the sensitivity to ½. The touch/non-touch threshold pixel value was 64 for the sensitivity of ¼ and is now recalculated equal to 128 for the sensitivity ½. If the sensitivity is set to ½ and the touch/non-touch threshold pixel value is less than or equal to 64, about a quarter of the saturation level, a sensitivity UP process is implemented to restore the sensitivity of the sensitivity of the image capture sensors 12 to 1/1.

Since the touch/non-touch threshold pixel value saturates at 255, if the touch/non-touch threshold pixel value is greater than or equal to 255, it is impossible to calculate to what level the touch/non-touch threshold pixel value has increased. Therefore, in the case of sensitivity DOWN, the sensitivity of the image capture sensors 12 is preferably reduced sequentially from 1/1 to ½ and ¼. However, in the case of sensitivity UP, the sensitivity of the image capture sensors 12 can jump from ¼ to 1/1 because the touch/non-touch threshold pixel value does not saturate. For example, when the sensitivity is set to ¼, if the touch/non-touch threshold pixel value suddenly decreases from about 128 to 32 or even less, the sensitivity may be increased to 1/1 instead of ½.

In other words, the optimal sensitivity calculation section 4 sets the sensitivity of the image capture sensors 12 in stages according to the touch/non-touch threshold pixel value. If the touch/non-touch threshold pixel value is less than or equal to a predetermined reference level, the section 4 increases the sensitivity of the image capture sensors 12 by two or more stages at once. The stages in setting up the sensitivity is not limited the aforementioned three stages; alternatively, two, four, or even more stages may be involved.

In addition, the optimal sensitivity calculation section 4 may set the sensitivity of the image capture sensors 12 in stages according to the external light intensity calculated by the external light intensity calculation section 3 and if the external light intensity has reached a predetermined reference level or less, increase the sensitivity of the image capture sensors 12 by two or more stages at once. The processing in that case is basically the same as the processing of setting the sensitivity of the image capture sensors 12 on the basis of the touch/non-touch threshold pixel value.

In addition, the sensitivity may be set to exhibit hysteresis to avoid frequent switching of sensitivity UP/DOWN due to small changes in the external light intensity. Specifically, if the sensitivity of the image capture sensors 12 is set to a first sensitivity (for example, sensitivity 1/1), when the external light intensity calculated by the external light intensity calculation section 3 has reached the first reference level (for example, 255), the optimal sensitivity calculation section 4 decreases the sensitivity of the image capture sensors 12 from the first sensitivity to a second sensitivity (for example, sensitivity ½) that is lower than the first sensitivity. If the sensitivity of the image capture sensors 12 is set to the second sensitivity, when the external light intensity decreases to the second reference level (for example, 64), the section 4 increases the sensitivity of the image capture sensors 12 from the second sensitivity to the first sensitivity. The second reference level is lower than the first reference level by a predetermined value. The predetermined value may be set in a suitable manner by a person skilled in the art.

The first and second reference levels may be stored in a memory section which is accessible to the optimal sensitivity calculation section 4.

The description above discussed the optimal sensitivity calculation section 4 giving hysteresis to the settings of the sensitivity of the image capture sensors 12 on the basis of the external light intensity. Hysteresis may be given similarly when the optimal sensitivity calculation section 4 sets the sensitivity of the image capture sensors 12 according to the touch/non-touch threshold pixel value.

In other words, the optimal sensitivity calculation section 4 may decrease the sensitivity of the image capture sensors 12 from the first sensitivity to the second sensitivity that is lower than the first sensitivity when the touch/non-touch threshold pixel value has reached the first reference level if the sensitivity of the image capture sensors 12 is set to the first sensitivity and may increase the sensitivity of the image capture sensors 12 from the second sensitivity to the first sensitivity when the touch/non-touch threshold pixel value has decreased to the second reference level if the sensitivity of the image capture sensors 12 is set to the second sensitivity, wherein the second reference level may be lower than the first reference level.

The increasing/decreasing of the sensitivity of the image capture sensors 12 according to the external light intensity as described in the foregoing enables adjustment of the dynamic range of the image to an optimal level and the recognition by means of optimal images.

### Process Flow in Touch Position Detection Device 10

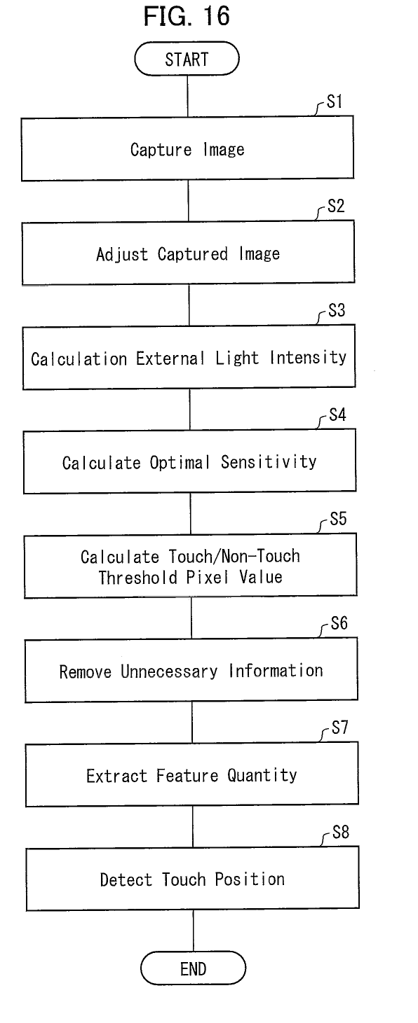

Next will be described an exemplary flow in touch position detection carried out by the touch position detection device 10 in reference to FIG. 16. FIG. 16 is a flow chart depicting an exemplary touch position detection carried out by the touch position detection device 10.

First, the image capture sensors 12 in the light sensor-containing LCD 11 capture an image of the pointing member. The image captured by the image capture sensors 12 is output via the AD converter 13 to the image adjustment section 2 (S1).

The image adjustment section 2, upon receiving the captured image (reception step), carries out calibration (adjustment of the gain and offset of the captured image) and other processes to output the adjusted captured image to the unnecessary recognition information removal section 6 (S2).

Meanwhile, upon the image being captured, the external light intensity calculation section 3 calculates the external light intensity as described earlier by using the output values produced by the external light sensors 15 at the time of the image capturing (external light intensity calculation step), to output the calculated external light intensity to the optimal sensitivity calculation section 4 and the touch/non-touch threshold pixel value calculation section 5 (S3). The external light intensity calculation section 3 recognizes that the image is captured by, for example, receiving from the light sensor-containing LCD 11 information indicating that the image has been captured.

The optimal sensitivity calculation section 4 calculates optimal sensitivity with which to recognize the pointing member according to the external light intensity calculated by the external light intensity calculation section 3, for output to the sensitivity adjustment section 14 (S4). The sensitivity adjustment section 14 adjusts the sensitivity of each image capture sensor 12 so that the sensitivity matches the optimal sensitivity output from the optimal sensitivity calculation section 4.

If the pixel values below a finger pad has at this point reached the saturation point, or if the external light intensity is lower than the predetermined value, the sensitivity adjustment section 14 adjusts the sensitivities of the image capture sensors 12. The sensitivity adjustment is reflected in a next frame captured image.

Next, the touch/non-touch threshold pixel value calculation section 5, s mentioned earlier, calculates the touch/non-touch threshold pixel value from the external light intensity calculated by the external light intensity calculation section 3 to output the calculated touch/non-touch threshold pixel value to the unnecessary recognition information removal section 6 (S5).

The unnecessary recognition information removal section 6, upon receiving the touch/non-touch threshold pixel value, replaces the pixel values for those pixels in the captured image which have pixel values greater than or equal to the touch/non-touch threshold pixel value with the touch/non-touch threshold pixel value to remove the information, in the captured image, which is unnecessary in recognizing the pointing member (in other words, information on the background of the pointing member) (S6). The unnecessary recognition information removal section 6 outputs the processed captured image to the feature quantity extraction section 7.

Upon receiving the captured image from the unnecessary recognition information removal section 6, the feature quantity extraction section 7 extracts a feature quantity indicating a feature of the pointing member (edge feature quantity) for each pixel in the captured image by edge detection and outputs the extracted feature quantity and positional information for a feature region showing the feature quantity (coordinates of the pixels) to the touch position detection section 8 (S7).

The touch position detection section 8, upon receiving the feature quantity and the positional information for the feature region, calculates a touch position by performing pattern matching on the feature region (S8). The touch position detection section 8 outputs the coordinates representing the calculated touch position to the application execution section 30.

If the image adjustment section 2 stores the adjusted captured image in the memory section 40, the unnecessary recognition information removal section 6 may obtain the captured image from the memory section 40.

### Embodiment 2

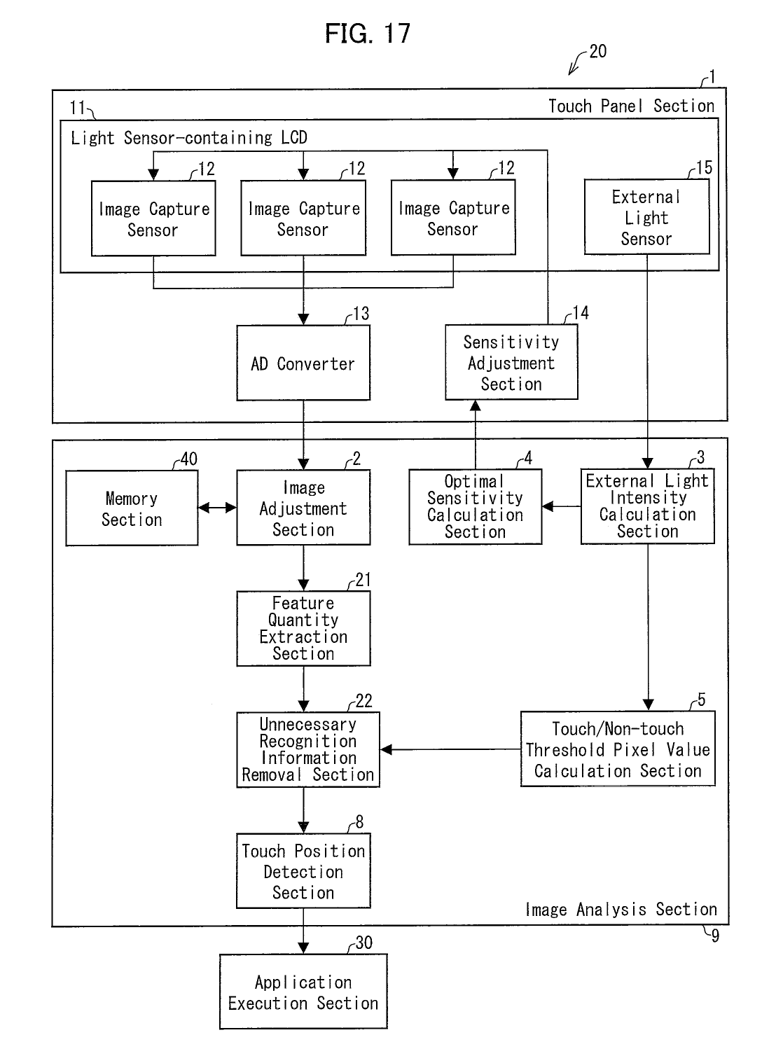

The following will describe another embodiment of the present invention in reference to FIGS. 17 to 19. The same members as those of embodiment 1 are indicated by the same reference numerals and description thereof is omitted.

### Configuration of Touch Position Detection Device 20

FIG. 17 is a block diagram of a touch position detection device 20 of the present embodiment. As illustrated in FIG. 17, the touch position detection device 20 differs from the touch position detection device 10 in that the former includes a feature quantity extraction section (feature region extraction means) 21 and an unnecessary recognition information removal section (removing means) 22.

The feature quantity extraction section 21 extracts a feature quantity indicating a feature of an image, of the pointing member in the captured image, which is output from the image adjustment section 2. The feature quantity extraction section 21 carries out the same process as does the feature quantity extraction section 7; the only difference is the targets to be processed.

The unnecessary recognition information removal section 22 removes at least part of the feature quantity extracted by the feature quantity extraction section 21 according to the external light intensity calculated by the external light intensity calculation section 3. To describe it in more detail, the unnecessary recognition information removal section 22 removes the feature quantity (feature region) which derives from the pixels having pixel values greater than or equal to the touch/non-touch threshold pixel value calculated by the touch/non-touch threshold pixel value calculation section 5. Removing the feature quantity associated with a pixel is equivalent to removing information on the feature region (pixels exhibiting the feature quantity); therefore, the removal of the feature quantity and the removal of the feature region have substantially the same meaning.

The touch position detection section 8 performs pattern matching on the feature quantity (feature region) from which noise has been removed by the unnecessary recognition information removal section 22 to identify the touch position.

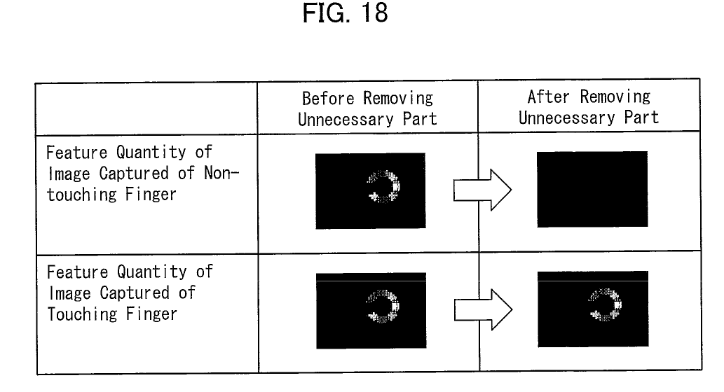

FIG. 18 is an illustration of the removal of unnecessary recognition information carried out by the unnecessary recognition information removal section 22. As illustrated in FIG. 18, the feature quantity of the image of the pointing member not in contact with the light sensor-containing LCD 11 contained in the non-touch captured image (pixels having pixel values greater than or equal to the touch/non-touch threshold pixel value) is removed by the unnecessary recognition information removal section 22. Therefore, the feature quantity (cyclic region) in the image under “Before Removing Unnecessary Part” in FIG. 18 is removed from the captured image of a non-touching pointing device and is not removed from the captured image of the touching pointing device.

The touch position detection device 10 of embodiment 1, as illustrated in FIG. 11, extracts a feature quantity after the relationship between the background pixel values and the pixel values below the finger pad are changed (after the differences between the background pixel values and the pixel values below the finger pad are narrowed). Therefore, to extract a feature quantity from the captured image from which unnecessary parts have been removed, a threshold for the extraction of an edge feature quantity needs to be changed (made less imposing).

Meanwhile, if the feature quantity corresponding to the pixels having pixel values greater than or equal to the touch/non-touch threshold pixel value is removed after the feature quantity is extracted as in the case of the touch position detection device 20 of the present embodiment, the parameter upon the feature quantity extraction does not need to be altered. This scheme is thus more effective.

For these reasons, the present embodiment employs a noise remove process using the touch/non-touch threshold pixel value after the feature quantity extraction from the captured image.

### Process Flow in Touch Position Detection Device 20

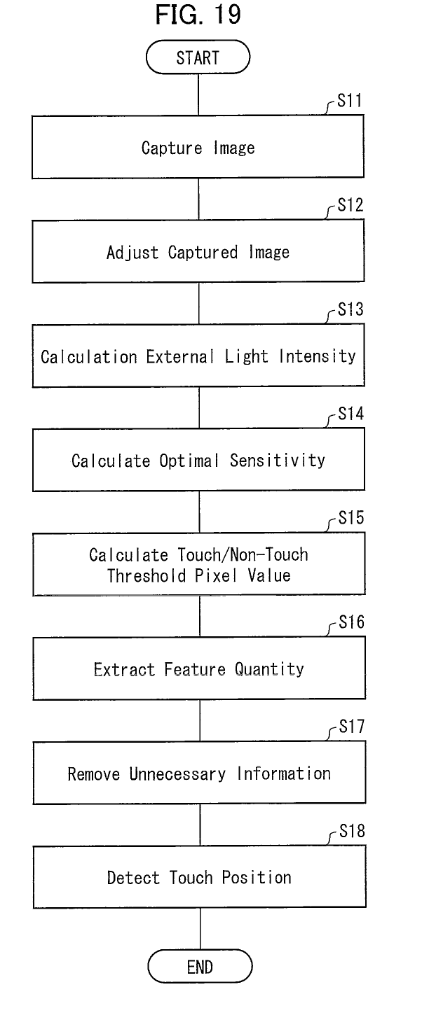

Next will be described an exemplary flow in touch position detection carried out by the touch position detection device 20 in reference to FIG. 19. FIG. 19 is a flow chart depicting an exemplary touch position detection carried out by the touch position detection device 20. Step S11 to S15 shown in FIG. 19 are the same as step SI to S5 shown in FIG. 16.

In step S15, the touch/non-touch threshold pixel value calculation section 5 outputs the calculated touch/non-touch threshold pixel value to the unnecessary recognition information removal section 22.

In step S16, the feature quantity extraction section 21 extracts a feature quantity indicating a feature of an image, of the pointing member in the captured image, which is output from the image adjustment section 2 and outputs the feature region data including the extracted feature quantity and positional information for a feature region showing the feature quantity to the unnecessary recognition information removal section 22 together with the captured image.

Upon receiving the touch/non-touch threshold pixel value from the touch/non-touch threshold pixel value calculation section 5 and the captured image and the feature region data from the feature quantity extraction section 21, the unnecessary recognition information removal section 22 removes the feature quantity which derives from the pixels having pixel values greater than or equal to the touch/non-touch threshold pixel value (S17). More specifically, the unnecessary recognition information removal section 22 obtains pixel values, for the pixels (feature region) in the captured image, which are associated with the feature quantity indicated by the feature region data by accessing the captured image and if the pixel values are greater than or equal to the touch/non-touch threshold pixel value, removes the feature quantity of the pixels from the feature region data. The unnecessary recognition information removal section 22 performs this process for each feature quantity indicated by the feature region data. The unnecessary recognition information removal section 22 outputs the processed feature region data to the touch position detection section 8.

The touch position detection section 8, upon receiving the feature region data processed by the unnecessary recognition information removal section 22, calculates a touch position by performing pattern matching on the feature region indicated by the feature region data (S18). The touch position detection section 8 outputs the coordinates representing the calculated touch position to the application execution section 30.

### Variations

The present invention is not limited to the description of the embodiments above, but may be altered by a skilled person within the scope of the claims. An embodiment based on a proper combination of technical means disclosed in different embodiments is encompassed in the technical scope of the present invention.

If the present invention is regarded as an image analysis device containing the touch/non-touch threshold pixel value calculation section 5, the unnecessary recognition information removal section 6 (or unnecessary recognition information removal section 22), and the feature quantity extraction section 7 (or feature quantity extraction section 21), the technological scope of the present invention encompasses a configuration, including no external light intensity calculation section 3, which externally obtains the external light intensity from the outside (for example, through user inputs).

The various blocks in the touch position detection device 10 and the touch position detection device 20, especially, the external light intensity calculation section 3, the optimal sensitivity calculation section 4, the touch/non-touch threshold pixel value calculation section 5, the unnecessary recognition information removal section 6, and the unnecessary recognition information removal section 22, may be implemented by hardware or software executed by a CPU as follows.

The touch position detection device 10 and the touch position detection device 20 each include a CPU (central processing unit) and memory devices (storage media). The CPU executes instructions contained in control programs, realizing various functions. The memory devices may be a ROM (read-only memory) containing programs, a RAM (random access memory) to which the programs are loaded, or a memory containing the programs and various data. The objectives of the present invention can be achieved also by mounting to the devices 10 and 20 a computer-readable storage medium containing control program code (executable programs, intermediate code programs, or source programs) for control programs (image analysis programs) for the devices 10 and 20, which is software realizing the aforementioned functions, in order for a computer (or CPU, MPU) to retrieve and execute the program code contained in the storage medium.

The storage medium may be, for example, a tape, such as a magnetic tape or a cassette tape; a magnetic disk, such as a floppy® disk or a hard disk, or an optical disc, such as a CD-ROM/MO/MD/DVD/CD-R; a card, such as an IC card (memory card) or an optical card; or a semiconductor memory, such as a mask ROM/EPROM/EEPROM/flash ROM.

The touch position detection device 10 and the touch position detection device 20 may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, a wired line, such as IEEE 1394, USB, an electric power line, a cable TV line, a telephone line, or an ADSL; or wireless, such as infrared (IrDA, remote control), Bluetooth, 802.11 wireless, HDR, a mobile telephone network, a satellite line, or a terrestrial digital network. The present invention encompasses a carrier wave, or data signal transmission, in which the program code is embodied electronically.

As described in the foregoing, the image capture device of the present invention is preferably such that the external light sensor has a lower sensitivity to light not transmitted by the pointing member than to light transmitted by the pointing member.

According to the configuration, the external light sensor detects some of the light transmitted by the pointing member, but has a low sensitivity to the light not transmitted by the pointing member. In calculating the external light intensity, it is preferable to selectively detect the light transmitted by the pointing member rather than the light not transmitted by the pointing member and calculate the external light intensity according to the intensity of the light transmitted by the pointing member because it will be easier to predict effects of the light transmitted by the pointing member from the calculated external light intensity.

The configuration thus enables more accurate calculation of the external light intensity.

The image capture device preferably includes two or more of the external light sensors, wherein the external light sensors are provided between the plurality of image capture sensors.

According to the configuration, the external light sensors are provided in proximity to the plurality of image capture sensors, which enables more accurate calculation of the external light intensity.

The image capture device preferably includes two or more of the external light sensors, wherein the external light sensors are provided adjacent to an outer edge section of a region in which the plurality of image capture sensors are provided.

According to the configuration, there are provided no external light sensors in the region in which the plurality of image capture sensors are provided, which prevents decreasing resolution of the image captured by the plurality of image capture sensors.

The image capture device preferably includes two or more of the external light sensors, wherein the external light intensity calculation means selects at least some of output values from the external light sensors indicating a quantity of light received by the external light sensors and designates, as the external light intensity, an output value ranked at a predetermined place in a descending order listing of the selected output values.

The external light could be blocked by the pointing member from hitting the external light sensors depending on the position of the external light sensors.

According to the configuration, the external light intensity calculation means selects at least some of output values from the external light sensors indicating the quantity of light received by the external light sensors and employs, as the external light intensity, an output value ranked at a predetermined place (for example, the tenth place) in a descending order listing of the selected output values.

Therefore, by appropriately setting the predetermined place, the external light intensity can be appropriately calculated according to an output value from an external light sensor which is unlikely to be affected by the pointing member.

The predetermined place is preferably within 10% of a total count of the selected output values.

According to the configuration, the external light intensity calculation means employs, as the external light intensity, an output value ranked within 10% of the total count of the selected output values. For example, if the total count of the selected pixels is 1,000, and the predetermined place is at the top 2% of the total count of the selected output values, the predetermined place is the 20-th place.

Since the external light intensity is calculated from one of the output values of the external light sensors, a suitable output value can be appropriately selected.

The image capture device preferably further includes sensitivity setup means for setting a sensitivity of the plurality of image capture sensors according to the external light intensity calculated by the external light intensity calculation means.

According to the configuration, an image is captured with a suitable sensitivity for recognition of the pointing member.

The sensitivity setup means preferably sets the sensitivity of the plurality of image capture sensors in stages and when the external light intensity is less than or equal to a predetermined reference level, increases the sensitivity of the plurality of image capture sensors by two or more stages at once.

According to the configuration, when the external light intensity is less than or equal to a predetermined reference level, the sensitivity setup means increases the sensitivity of the plurality of image capture sensors by two or more stages at once. Therefore, a suitable image is captured more quickly than by gradually increasing the sensitivity.

The image capture device preferably further includes:

reference level calculation means for calculating, from the external light intensity calculated by the external light intensity calculation means, a determination reference level which is a pixel value reference level according to which to determine whether or not an image contained in the captured image is attributable to a part, of the pointing member, which is in contact with the image capture screen; and

sensitivity setup means for setting a sensitivity of the plurality of image capture sensors according to the determination reference level calculated by the reference level calculation means.

According to the configuration, the reference level calculation means calculates a determination reference level according to which to determine whether or not an image contained in the captured image is attributable to a part, of the pointing member, which is in contact with the image capture screen. The sensitivity setup means sets the sensitivity of the plurality of image capture sensors according to the determination reference level.

It is possible to capture an image with a suitable sensitivity in order to analyze an image contained in the captured image attributable to a part, of the pointing member, which is in contact with the image capture screen.

The sensitivity setup means preferably sets the sensitivity of the plurality of image capture sensors in stages and when the determination reference level is less than or equal to a predetermined value, increases the sensitivity of the plurality of image capture sensors by two or more stages at once.

According to the configuration, when the determination reference level is less than or equal to a predetermined value, the sensitivity setup means increases the sensitivity of the plurality of image capture sensors by two or more stages at once. Therefore, a suitable image is captured more quickly than by gradually increasing the sensitivity.

The sensitivity setup means preferably sets the sensitivity of the plurality of image capture sensors so that pixel values for pixels forming an image of a part, of the pointing member, which is in contact with the image capture screen do not saturate.

If the pixel values for the pixels forming the image of the contact part of the pointing member saturates, the image of the pointing member is recognized with reduced precision.

According to the configuration, an image is captured with such a sensitivity that the pixel values for the pixels forming the image of the contact part of the pointing member do not saturate. A suitable image is captured for recognition of the pointing member.

The sensitivity setup means preferably decreases the sensitivity of the plurality of image capture sensors from a first sensitivity to a second sensitivity lower than the first sensitivity when the external light intensity has reached a first reference level if the sensitivity is set to the first sensitivity and increases the sensitivity of the plurality of image capture sensors from the second sensitivity to the first sensitivity when the external light intensity has decreased to a second reference level if the sensitivity is set to the second sensitivity, the second reference level being lower than the first reference level.

According to the configuration, the second reference level which provides a reference for the external light intensity (calculated by the external light intensity calculation means) according to which the sensitivity of the plurality of image capture sensors is increased to the first sensitivity if the sensitivity of the plurality of image capture sensors is set to the second sensitivity is lower than the first reference level which provides reference for the external light intensity (calculated by the external light intensity calculation means) according to which the sensitivity of the plurality of image capture sensors is decreased to the second sensitivity if the sensitivity of the plurality of image capture sensors is set to the first sensitivity.

This reduces the possibility that when the sensitivity of the plurality of image capture sensors is decreased from the first sensitivity to the second sensitivity, the external light intensity calculated by the external light intensity calculation means quickly reaches the second reference level, and the sensitivity of the plurality of image capture sensors switches again to the first sensitivity. The configuration thus prevents small changes in the external light intensity from causing frequent switching of the sensitivity of the plurality of image capture sensors from the first sensitivity to the second sensitivity or from the second sensitivity to the first sensitivity.

The sensitivity setup means preferably decreases the sensitivity of the plurality of image capture sensors from a first sensitivity to a second sensitivity lower than the first sensitivity when the determination reference level has reached a first reference level if the sensitivity is set to the first sensitivity and increases the sensitivity of the plurality of image capture sensors from the second sensitivity to the first sensitivity when the determination reference level has decreased to a second reference level if the sensitivity is set to the second sensitivity, the second reference level being lower than the first reference level.

According to the configuration, the second reference level which provides a reference for the determination reference level (calculated by the reference level calculation means) according to which the sensitivity of the plurality of image capture sensors is increased to the first sensitivity if the sensitivity of the plurality of image capture sensors is set to the second sensitivity is lower than the first reference level which provides a reference for the determination reference level (calculated by the reference level calculation means) according to which the sensitivity of the plurality of image capture sensors is decreased to the second sensitivity if the sensitivity of the plurality of image capture sensors is set to the first sensitivity.

This reduces the possibility that when the sensitivity of the plurality of image capture sensors is decreased from the first sensitivity to the second sensitivity, the determination reference level calculated by the reference level calculation means quickly reaches the second reference level, and the sensitivity of the plurality of image capture sensors switches again to the first sensitivity. The configuration thus prevents small changes in the external light intensity from causing frequent switching of the sensitivity of the plurality of image capture sensors from the first sensitivity to the second sensitivity or from the second sensitivity to the first sensitivity.

The scope of the present invention encompasses an image capture program, for operating the image capture device, which causes a computer to function as the individual means and also encompasses a computer-readable storage medium containing the image capture program.

In the image analysis device of the present invention, the reference level calculation means preferably calculates the reference level by selectively using one of predetermined equations according to the external light intensity.

The configuration enables calculation of a reference level appropriate to the external light intensity according to changes in the external light intensity. For example, the reference level calculation means can calculate the reference level by a first equation when the external light intensity is in a first range and by a second equation when the external light intensity is in a second range.

An image analysis device in accordance with the present invention is, to address the problems, characterized in that it is an image analysis device for analyzing an image of a pointing member being in contact or not in contact with an image capture screen containing a plurality of image capture sensors, the image being captured by the plurality of image capture sensors, the device including:

reception means for receiving the captured image;

reference level calculation means for calculating, from an external light intensity which is an intensity of light in the surroundings of the pointing member, a pixel value reference level according to which to remove an image of the pointing member when the pointing member is not in contact with the image capture screen from the captured image; and

image processing means for replacing a pixel value, for a pixel contained in the captured image received by the reception means, which is greater than or equal to the reference level calculated by the reference level calculation means with the reference level.

An image analysis method in accordance with the present invention is, to address the problems, characterized in that it is an image analysis method implemented by an image analysis device for analyzing an image of a pointing member being in contact or not in contact with an image capture screen containing a plurality of image capture sensors, the image being captured by the plurality of image capture sensors, the method including:

the reception step of receiving the captured image;

the reference level calculation step of calculating, from an external light intensity which is an intensity of light in the surroundings of the pointing member, a pixel value reference level according to which to remove an image of the pointing member when the pointing member is not in contact with the image capture screen from the captured image; and

the image processing step of replacing a pixel value, for a pixel contained in the captured image received in the reception step, which is greater than or equal to the reference level calculated in the reference level calculation step with the reference level.

According to the configuration, the reference level calculation means calculates, from the external light intensity, a pixel value reference level according to which to remove an image of the pointing member when the pointing member is not in contact with the image capture screen from the captured image. The image processing means then replaces a pixel value, for a pixel contained in the captured image, which is greater than or equal to the reference level with the reference level.

Therefore, when the pointing member is not in contact with the image capture screen, the pixel values for the pixels forming the image of the pointing member and the pixel values for the pixels corresponding to the background are all reduced to the reference level, forming a uniform background. Therefore, when the pointing member is not in contact with the image capture screen, the image of the pointing member is removed from the captured image.

As a result, the image, of the pointing member when the pointing member is not in contact with the image capture screen, which is unnecessary in recognizing the pointing member is removed from the captured image. That improves precision in recognizing the pointing member.

The scope of the present invention encompasses an image analysis program, for operating the image analysis device, which causes a computer to function as the individual means and also encompasses a computer-readable storage medium containing the image analysis program.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

1. An image capture device including an image capture screen containing a plurality of image capture sensors, said device capturing an image of a pointing member being placed near the image capture screen with the plurality of image capture sensors, said device comprising:
at least one external light sensor provided in proximity to the plurality of image capture sensors, the external light sensor having a lower light detection sensitivity than the plurality of image capture sensors; and
external light intensity calculation means for calculating an external light intensity which is an intensity of light from the surroundings of the pointing member, the external light intensity calculation means calculating the external light intensity according to a quantity of the light received by the external light sensor.

2. The image capture device as set forth in claim 1, wherein the external light sensor has a lower sensitivity to light not transmitted by the pointing member than to light transmitted by the pointing member.

3. The image capture device as set forth in claim 1, comprising two or more of said external light sensors, wherein the external light sensors are provided between the plurality of image capture sensors.

4. The image capture device as set forth in claim 1, comprising two or more of said external light sensors, wherein the external light sensors are provided adjacent to an outer edge section of a region in which the plurality of image capture sensors are provided.

5. The image capture device as set forth in claim 1, comprising two or more of said external light sensors, wherein the external light intensity calculation means designates, as the external light intensity, an output value ranked at a predetermined place in a descending order listing of at least some of output values from the external light sensors indicating the quantities of the light received by the external light sensors.

6. The image capture device as set forth in claim 5, wherein the predetermined place is within 10% of a total count of said at least some of output values.

7. The image capture device as set forth in claim 1, further comprising sensitivity setup means for setting a sensitivity of the plurality of image capture sensors according to the external light intensity calculated by the external light intensity calculation means.

8. The image capture device as set forth in claim 7, wherein the sensitivity setup means sets the sensitivity of the plurality of image capture sensors in stages and when the external light intensity is less than or equal to a predetermined reference level, increases the sensitivity of the plurality of image capture sensors by two or more stages at once.

9. The image capture device as set forth in claim 1, further comprising:
reference level calculation means for calculating, from the external light intensity calculated by the external light intensity calculation means, a determination reference level which is a pixel value reference level according to which to determine whether or not an image contained in the captured image is attributable to a part, of the pointing member, which is in contact with the image capture screen; and
sensitivity setup means for setting a sensitivity of the plurality of image capture sensors according to the determination reference level calculated by the reference level calculation means.

10. The image capture device as set forth in claim 9, wherein the sensitivity setup means sets the sensitivity of the plurality of image capture sensors in stages and when the determination reference level is less than or equal to a predetermined value, increases the sensitivity of the plurality of image capture sensors by two or more stages at once.

11. The image capture device as set forth in claim 7, wherein the sensitivity setup means sets the sensitivity of the plurality of image capture sensors so that pixel values for pixels forming an image of a part, of the pointing member, which is in contact with the image capture screen do not saturate.

12. The image capture device as set forth in claim 7, wherein the sensitivity setup means decreases the sensitivity of the plurality of image capture sensors from a first sensitivity to a second sensitivity lower than the first sensitivity when the external light intensity has reached a first reference level if the sensitivity is set to the first sensitivity and increases the sensitivity of the plurality of image capture sensors from the second sensitivity to the first sensitivity when the external light intensity has decreased to a second reference level if the sensitivity is set to the second sensitivity, the second reference level being lower than the first reference level.

13. The image capture device as set forth in claim 9, wherein the sensitivity setup means decreases the sensitivity of the plurality of image capture sensors from a first sensitivity to a second sensitivity lower than the first sensitivity when the determination reference level has reached a first reference level if the sensitivity is set to the first sensitivity and increases the sensitivity of the plurality of image capture sensors from the second sensitivity to the first sensitivity when the determination reference level has decreased to a second reference level if the sensitivity is set to the second sensitivity, the second reference level being lower than the first reference level.

14. An image capture program for operating the image capture device as set forth in claim 1, said program causing a computer to function as the individual means.

15. A computer-readable storage medium containing the image capture program as set forth in claim 14.

16. An external light intensity calculation method implemented by an image capture device including an image capture screen containing a plurality of image capture sensors, the device capturing an image of a pointing member being placed near the image capture screen with the plurality of image capture sensors, said method comprising:
the external light intensity calculation step of calculating an external light intensity which is an intensity of light incident to at least one external light sensor from the surroundings of the pointing member, the external light intensity calculation step of calculating the external light intensity according to a quantity of the light received by the external light sensor, the external light sensor being provided in proximity to the plurality of image capture sensors and having a lower light detection sensitivity than the plurality of image capture sensors.

17. An image analysis device for analyzing an image of a pointing member being placed near an image capture screen containing a plurality of image capture sensors, the image being captured by the plurality of image capture sensors, said device comprising:
reception means for receiving the captured image;
reference level calculation means for calculating, from an external light intensity which is an intensity of light in the surroundings of the pointing member, a pixel value reference level according to which to remove an image other than an image of a part, of the pointing member, which is in contact with the image capture screen from the captured image; and
image processing means for altering a pixel value for at least one of pixels contained in the captured image according to the reference level calculated by the reference level calculation means.

18. The image analysis device as set forth in claim 17, wherein the image processing means replaces a pixel value, for a pixel contained in the captured image received by the reception means, which is greater than or equal to the reference level calculated by the reference level calculation means with the reference level.

19. The image analysis device as set forth in claim 17, wherein the reference level calculation means calculates the reference level by selectively using one of predetermined equations according to the external light intensity.

20. An image analysis program for operating the image analysis device as set forth in claim 17, said program causing a computer to function as the individual means.

21. A computer-readable storage medium containing the image analysis program as set forth in claim 20.

22. An image analysis device for analyzing an image of a pointing member being placed near an image capture screen containing a plurality of image capture sensors, the image being captured by the plurality of image capture sensors, said device comprising:
reception means for receiving the captured image;
feature region extraction means for extracting a feature region showing a feature of an image of the pointing member from the captured image received by the reception means;
reference level calculation means for calculating, from an external light intensity which is an intensity of light in the surroundings of the pointing member, a pixel value reference level according to which to determine whether or not the feature region is attributable to an image of a part, of the pointing member, which is in contact with the image capture screen;
removing means for removing a feature region attributable to a pixel having a pixel value greater than or equal to the reference level calculated by the reference level calculation means from the feature region extracted by the feature region extraction means; and
position calculation means for calculating a position of the image of the part, of the pointing member, which is in contact with the image capture screen from a feature region not removed by the removing means.

23. The image analysis device as set forth in claim 22, wherein the reference level calculation means calculates the reference level by selectively using one of predetermined equations according to the external light intensity.

24. An image analysis program for operating the image analysis device as set forth in claim 23, said program causing a computer to function as the individual means.

25. A computer-readable storage medium containing the image analysis program as set forth in claim 24.

26. An image analysis method implemented by an image analysis device for analyzing an image of a pointing member being placed near an image capture screen containing a plurality of image capture sensors, the image being captured by the plurality of image capture sensors, said method comprising:
the reception step of receiving the captured image;
the reference level calculation step of calculating, from an external light intensity which is an intensity of light in the surroundings of the pointing member, a pixel value reference level according to which to remove an image other than an image of a part, of the pointing member, which is in contact with the image capture screen from the captured image; and
the image processing step of altering a pixel value for at least one of pixels contained in the captured image according to the reference level calculated in the reference level calculation step.

27. An image analysis method implemented by an image analysis device for analyzing an image of a pointing member being placed near an image capture screen containing a plurality of image capture sensors, the image being captured by the plurality of image capture sensors, said method comprising:
the reception step of receiving the captured image;
the feature region extraction step of extracting a feature region showing a feature of an image of the pointing member contained in the captured image received in the reception step;
the reference level calculation step of calculating, from an external light intensity which is an intensity of light in the surroundings of the pointing member, a pixel value reference level according to which to determine whether or not the feature region is attributable to a part, of the pointing member, which is in contact with the image capture screen;
the removing step of removing a feature region attributable to a pixel having a pixel value greater than or equal to the reference level calculated in the reference level calculation step from the feature region extracted in the feature region extraction step; and
the position calculation step of calculating a position of an image of the part, of the pointing member, which is in contact with the image capture screen from a feature region not removed in the removing step.
